(19) United States
(12) Patent Application Publication
(10) Pub. No.: US 2025/0252319 A1
(43) Pub. Date: Aug. 7, 2025

(54) METHODS AND SYSTEMS FOR GENERATING, TRAINING, COMBINING, AND USING FEDERATED LARGE LANGUAGE MODELS (LLMs) IN AN ENTERPRISE CONTEXT

(71) Applicants: Souvik Sen, Sunnyvale, CA (US); Surojit Chatterjee, Los Altos, CA (US)

(72) Inventors: Souvik Sen, Sunnyvale, CA (US); Surojit Chatterjee, Los Altos, CA (US)

(73) Assignee: Ema Unlimited Inc., San Francisco, CA (US)

(21) Appl. No.: 18/433,598

(22) Filed: Feb. 6, 2024

(51) Int. Cl. G06N 3/098

(52) U.S. Cl. CPC G06N 3/098

(57) ABSTRACT

Systems and methods for using enterprise data to train and generate enterprise related large language models (ELLMs) and selectively combining the generated ELLMs and publicly available LLMs to generate a customized LLM for automatically answering queries are disclosed. Enterprise data is obtained, classified, and curated to generate training data that is used to generate a plurality of contextually distinguished ELLMs. The ELLMs differ based on their relation to various enterprise functions, departments, and level of authorized access to enterprise confidential data. When a question is received from a user, both the identity of the user and context of the question are used to select one or more ELLMs and LLMs for processing the question. The processing involves sequential selection of a plurality of ELLMs to process the question, blend the results from the processing, and use the results as input into an ensemble model to obtain a final answer.

### FIELD OF INVENTION

Embodiments of the present disclosure relate to generating and training large language models (LLMs) based on enterprise context, selectively combining the trained LLMs, including any publicly available LLMs, and using the combinations to generate a customized LLM for automatically answering queries in an enterprise environment.

### BACKGROUND

Use of artificial intelligence (AI) is on the rise. Some of the most frequently used AI platforms and chatbots include ChatGPT™, Bard™, Llama™, Bing chat™, Claude™, and Jasper™. Users use these AI platforms or chatbots for many reasons, such as to accelerate their workflow, search for answers, get responses to their queries, or to obtain guidance. To do so, users may enter a question or a request in a prompt provided by the AI platform or a prompt generated by an upstream system. The question or request entered may vary in complexity from a simple to a more complex question or request. An example of a simple question or request includes seeking a simple answer to a 5th grade math question or having the algorithm associated with the AI platform assist a user in writing a thank you note after an interview. An example of complex request includes using the AI platform to troubleshoot a data security vulnerability for a company or having the AI algorithm associated with platform write portions of code for a software product.

To respond to the user's request or question entered in the prompt or a prompt generated by an upstream system, the AI platform, also referred to as an AI chatbot, may use a large language model (LLM). As depicted in FIG. 1, the AI platform may use data 101 from various sources to equip and train the LLM 102 and use the trained LLM 102 to respond to the question or request 103. The data 101 used for training the LLM 102 is typically very large in size and obtained from various sources, such as websites, articles, and books. Typical data sets used for AI platforms such as ChatGPT and Bard may range in several petabytes.

Once data 101 is obtained, it may be used to train the LLM 102. Deep learning techniques may be used to analyze the data obtained and identify patterns to establish connection between words. Techniques used to detect such pattern recognition and establish a connection may mimic natural language spoken by humans. For example, the techniques used may use words from the data set and generate semantic and grammatical relationships that allow it to generate a cohesive and logical answer to the question 103, in a same manner as a human would answer a question.

Numerical or weighted values may be assigned to the connections between words that are established. Such connections with numerical values are typically referred to as parameters. A large scale LLM may have over a billion parameters while smaller sized LLMs may have lesser parameters. The larger the data 101 set used, the larger the LLM and its ability to respond to questions and requests and generate new content. The weighted parameters may be used to determine the strength of connections between neurons that may affect the strength of the response provided to the question/request 103.

Once an LLM 102 is generated, it may be used to provide an answer 104 to questions/requests 103 inputted in a prompt provided by the AI platform or in a prompt generated by an upstream system. Questions may be a simple one query question, or a more complex question that include multiple parts or requires an explanation of the answer as depicted in FIG. 2. When the question or request is more complex, as depicted at 201 in FIG. 2, the question may be decomposed at 202. The decomposing may include separating the question into multiple parts for a better understanding and to allow focus on each part of the question separately for producing the best results. Prompt design 203, which is a technique to select the right words and guide the LLM in generating high quality results may also be used.

The LLM may be used to understand the question, such as the simple question at 103 or more complex question at 201, and use deep learning techniques to understand and summarize the question and generate the answer 104 or 204. By doing so, the AI platform may provide a basis for a user to communicate with the AI platform and receive new ideas, concepts, or answers to their questions.

Although current AI platforms are useful in answering questions or responding to requests inputted by a user, they still have several drawbacks. For example, one of the drawbacks include the AI platform's dependency on a single LLM model that has been trained by the AI platform. Such dependency on a single LLM model may be limited based on the data set used to train the model and may not produce the best results.

Yet another drawback with the current AI platforms is that the answer provided is a direct response to the question inputted. It does not take into account any other factors besides the question inputted to determine the type of answer to provide. In other words, the answer is likely the same regardless of which user is asking the question. Although an answer that responds to the question inputted may be produced, not considering other factors and providing the same response regardless of the user may result in an answer that is not properly understood by the user.

As such, there is a need for a system and method for generating one or more robust LLMs and considering additional factors in using the generated LLMs.

### BRIEF DESCRIPTION OF THE DRAWINGS

FIGS. 1 and 2 are prior art methods for using an LLM to obtain an answer.

The various objects and advantages of the disclosure will be apparent upon consideration of the following detailed description, taken in conjunction with the accompanying drawings, in which like reference characters refer to like parts throughout, and in which:

FIG. 3 is a flowchart of an example of a process for generating and training federated large language models (LLMs) and combining and using them in an enterprise context, in accordance with some embodiments of the disclosure;

FIG. 4 is a block diagram of an example of a system for generating and training federated large language models (LLMs) and combining and using them in an enterprise context, in accordance with some embodiments of the disclosure;

FIG. 5 is a block diagram of an example of an electronic device used for entering commands or queries, executing functions relating to generating, training, combining and using LLMs, and displaying answers provided by LLMs in a user interface, in accordance with some embodiments of the disclosure;

FIG. 6 is flowchart of an example of a process for obtaining enterprise data and generating and training enterprise LLMs (ELLMs), in accordance with some embodiments of the disclosure;

FIG. 7 is a block diagram of an example of using enterprise data to generated federated enterprise LLMs, in accordance with some embodiments of the disclosure;

FIG. 8 is a block diagram of an example for determining data classification and curating data quality for its use to train an enterprise LLM, in accordance with some embodiments of the disclosure;

FIG. 9 is flowchart of an example of a multi-layer process for selecting a plurality of LLMs to obtain a curated/enhanced answer, in accordance with some embodiments;

FIG. 10 is a block diagram of an example of enterprise and public LLMs and their use to obtain a curated/enhanced answer, in accordance with some embodiments;

FIG. 11A is an example of a simple question that may be entered for obtaining a curated/enhanced answer as described in FIGS. 9-10, in accordance with some embodiments of the disclosure;

FIG. 11B is an example of a multi-part question or a more descriptive question that may be entered for obtaining a curated/enhanced answer as described in FIGS. 9-10, in accordance with some embodiments of the disclosure;

FIG. 12 is a block diagram of an example of matching an ELLM to a question based on the context of the question and the user credentials, in accordance with some embodiments of the disclosure;

FIG. 13 is a block diagram of an example of selection criteria used for selecting an ELLM, in accordance with some embodiments of the disclosure;

FIG. 14 is a block diagram of an example of different tiers of access levels associated with different tiers of employees based on their job titles, in accordance with some embodiments of the disclosure;

FIG. 15 is a block diagram of an example of selecting ELLMs from different departments in a company based on their contextual relationship to the input question, in accordance with some embodiments of the disclosure;

FIG. 16 is a block diagram of an example of a nested ELLM, in accordance with some embodiments of the disclosure;

FIG. 17 is a block diagram of an example of using public LLMs to answer a question, in accordance with some embodiments of the disclosure;

FIG. 18 is a block diagram of an example of using ELLMs to answer a question, in accordance with some embodiments of the disclosure;

FIG. 19 is a block diagram of an example of using both public LLMs and ELLMs to answer a question, in accordance with some embodiments of the disclosure;

FIGS. 20A and 20B are exemplary tables is that depict cost and accuracy provided by each LLM (or ELLM) that may be used in narrowing the selection of LLMs and ELLMs to process a query, in accordance with some embodiments of the disclosure; and

FIG. 20C is an exemplary table that may be used to determine accuracy parameters based on the importance level of the query, in accordance with some embodiments of the disclosure.

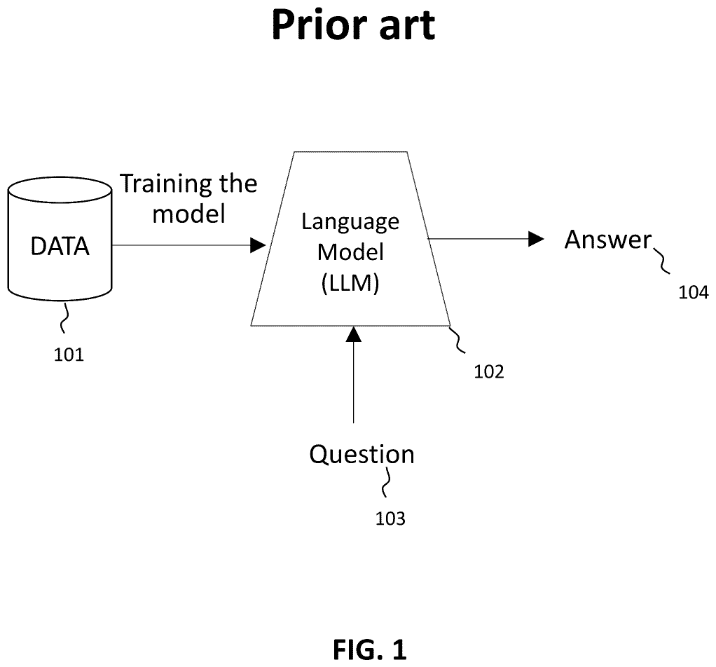

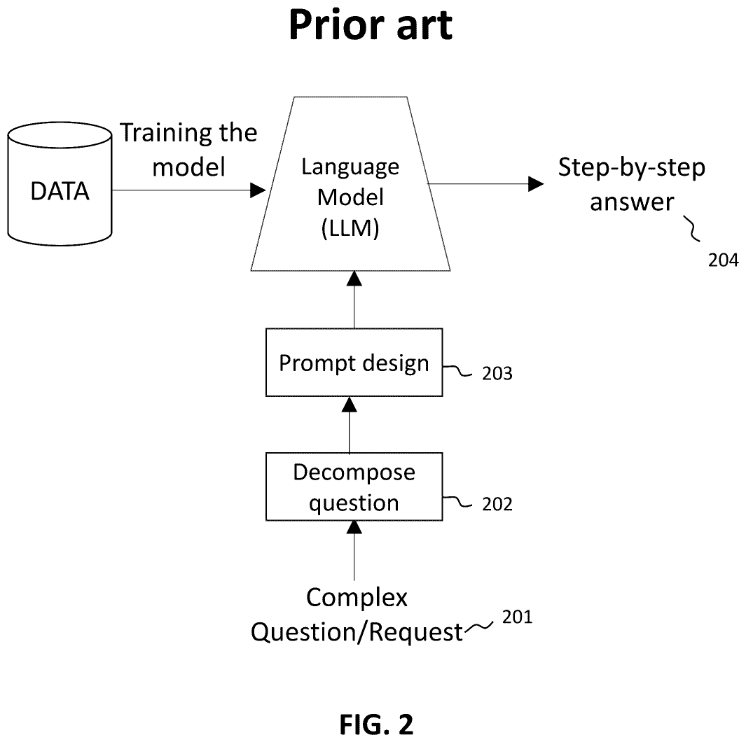

### DETAILED DESCRIPTION

In accordance with some embodiments disclosed herein, the above-mentioned limitations are overcome by obtaining enterprise data from a plurality of enterprise resources, classifying and curating the obtained data, such as based on data quality and data type, generating training data from the classified and curated data, and using the training data to generate a plurality of contextually distinguished ELLMs. The above-mentioned limitations are also overcome by associating the training data with one or more enterprise functions and departments. The above-mentioned limitations are also overcome by associating the training data with different level of access, including different levels of authorization for different employees of an enterprise, such as based on the confidential and proprietary nature of the training data. The association with one or more enterprise functions and departments and the level of access/authorization, among other factors, is taken into consideration to generate contextually distinguished ELLMs. For example, an ELLMs that has been trained on finance data may be generated separately from another ELLM that has been trained with engineering data. Likewise, an ELLM that has been trained with a higher tier of confidential data may be generated separately from an ELLM that has been trained with data with a lower tier of confidentiality and is available to all employees of the enterprise. The above-mentioned limitations are also overcome by selectively combining one or more generated ELLMs, as well as any publicly available LLMs, where the combinations of ELLMs and LLMs are selected based on both the identity of the user as well as the context of the question. The selected combination of ELLMs and LLMs are used to process a question inputted by a user. Answers obtained by processing the question via the combination of ELLMs and LLMs are blended and used as an input into an ensemble model to obtain a final answer.

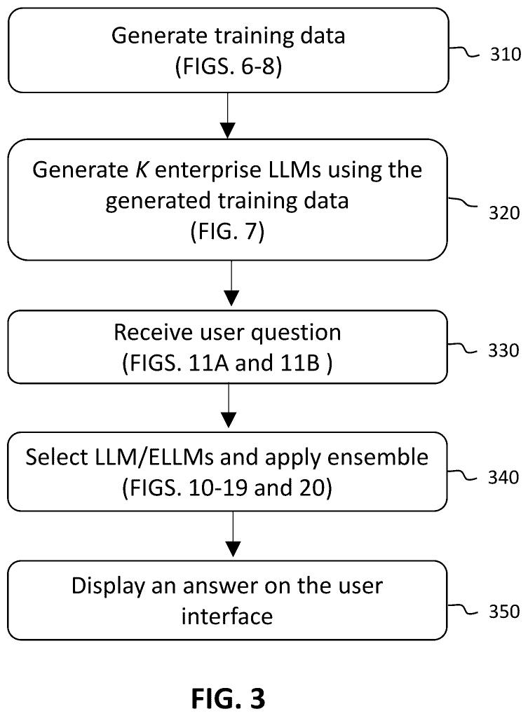

Turning to the figures, FIG. 3 is a flowchart 300 of an example of a process for generating and training enterprise related federated large language models (ELLMs) and combining and using them in an enterprise context, in accordance with some embodiments of the disclosure.

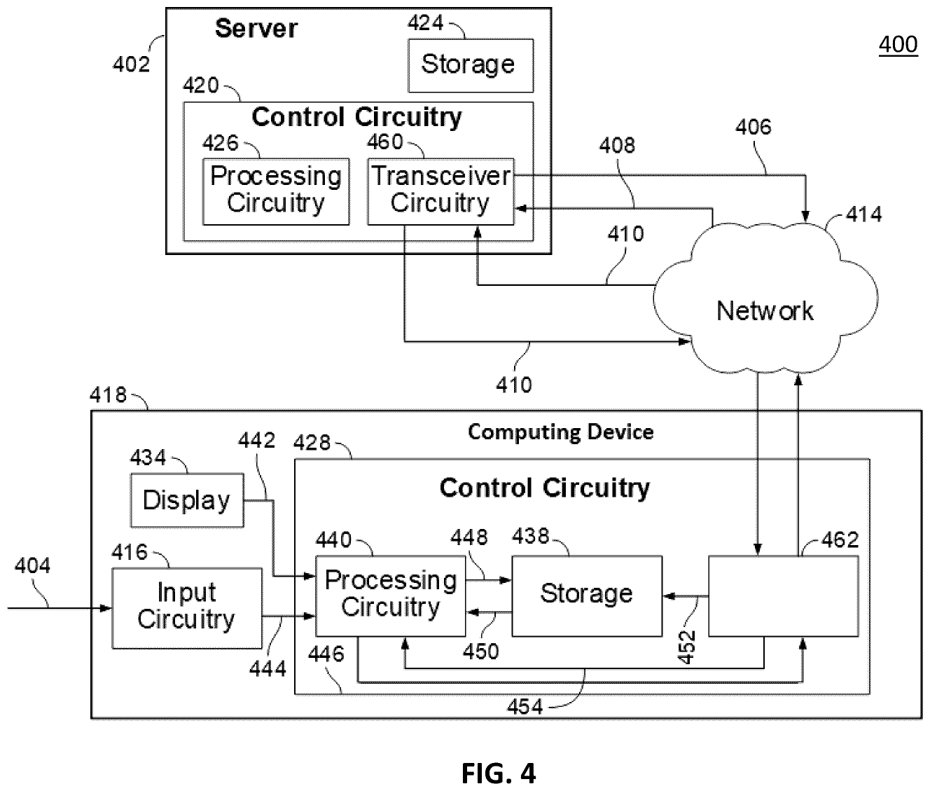

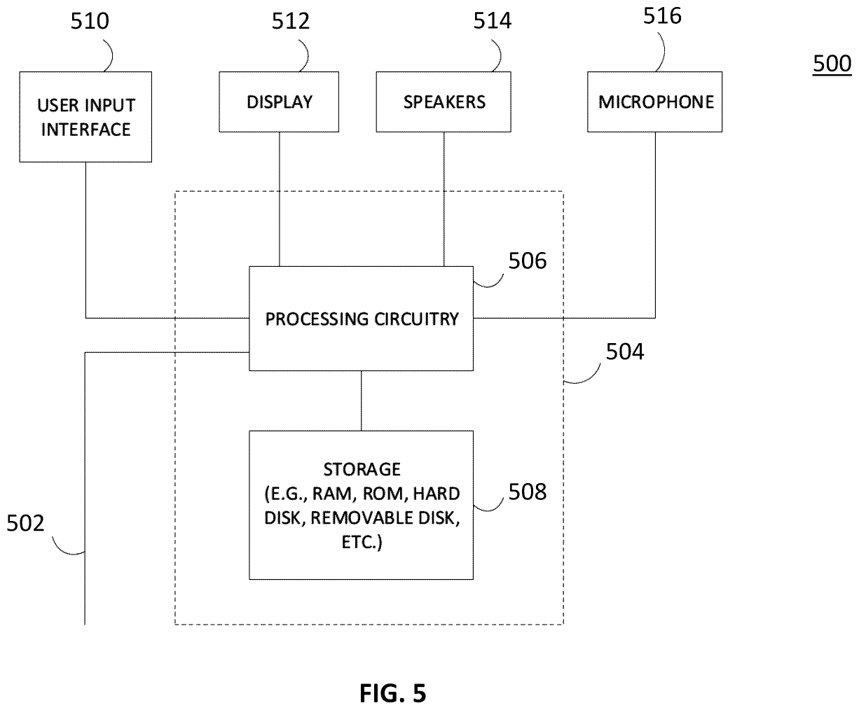

The process 300 may be implemented, in whole or in part, by systems or devices such as those shown in FIGS. 4-5. One or more actions of the process 300 may be incorporated into or combined with one or more actions of any other process or embodiments described herein. The process 300 may be saved to a memory or storage (e.g., any one of those depicted in FIGS. 4-5) as one or more instructions or routines that may be executed by a corresponding device or system to implement the method 300.

In some embodiments, at block 310, training data may be generated. The training data may be used for generating and training enterprise based large language models, herein referred to as ELLM(s), enterprise LLM(s), private LLM(s) or federated large language models. Generating training data to generate an ELLM, in some embodiments, involves accessing various databases, executable applications, document libraries, various servers, such as email server, department servers, and any storage devices and applications used by the enterprise for storing data.

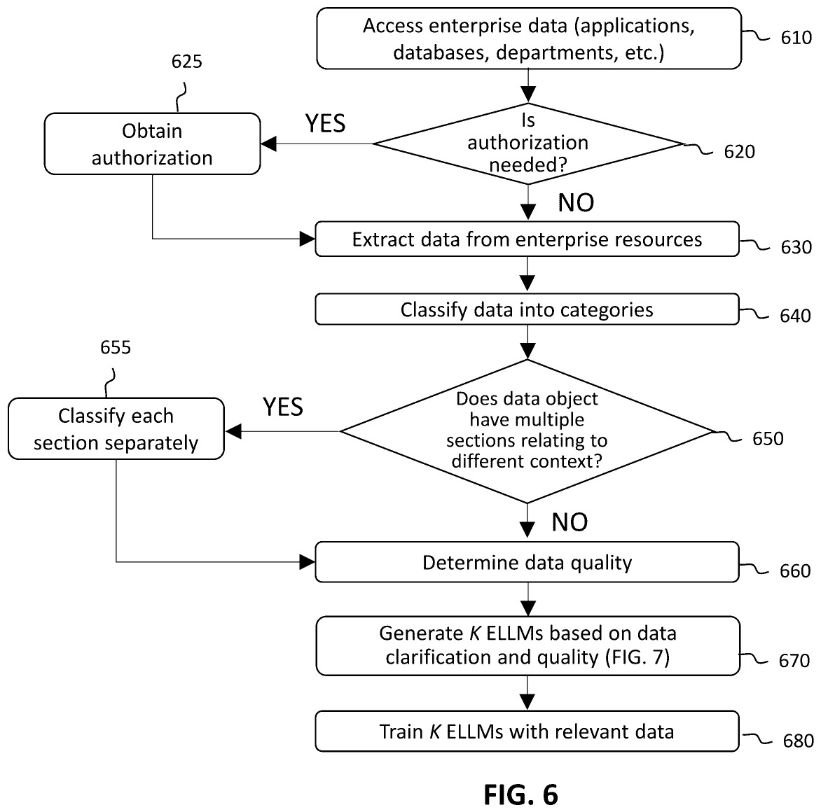

Training an ELLM using enterprise data and using it to answer enterprise related queries provides several advantages. For example, an ELLM is private, i.e., the data used to train the ELLM is not publicly shared and its data privacy and security is protected. In another example, it is easier to update an ELLM. Since the training data is managed within the enterprise, system administrators or managers associated with the data within the enterprise may be able to have a higher level of control over updates, improvements, deletions, and changes in use of enterprise data and be able to change it easily and quickly as needed. For example, a trained ELLM may be updated internally at an enterprise by using updated data from a department to replace older data and obtain a curated answer to a related question. Since responses to some of the questions provided to an ELLM may affect the outcomes of decisions made in a company, including decisions relating to key company business and strategy, ensuring that the training data used in the ELLMs is classified, updated, and quality checked accurately becomes very critical. Furthermore, having a properly classified and quality checked ELLM also allows the enterprise to have the most control of the ELLM's performance and ensure that proper, updated, and accurate data is being used. FIGS. 6-8 describe in further detail some embodiments of how such enterprise data is accessed, classified, curated for quality, and made available for it to be used as training data for ELLMs.

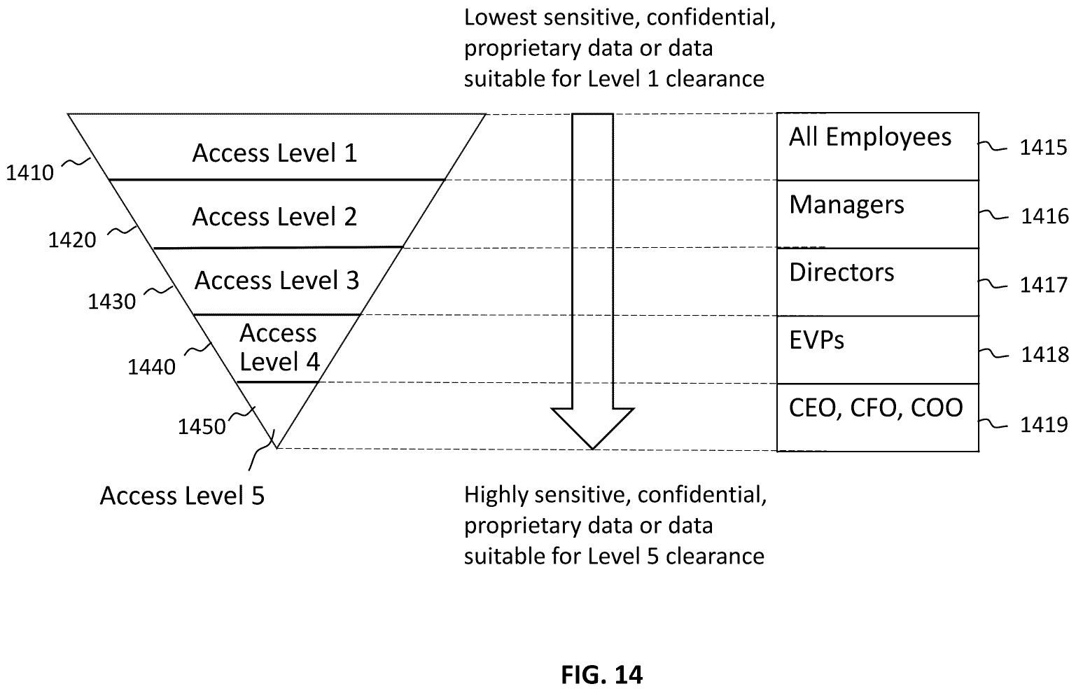

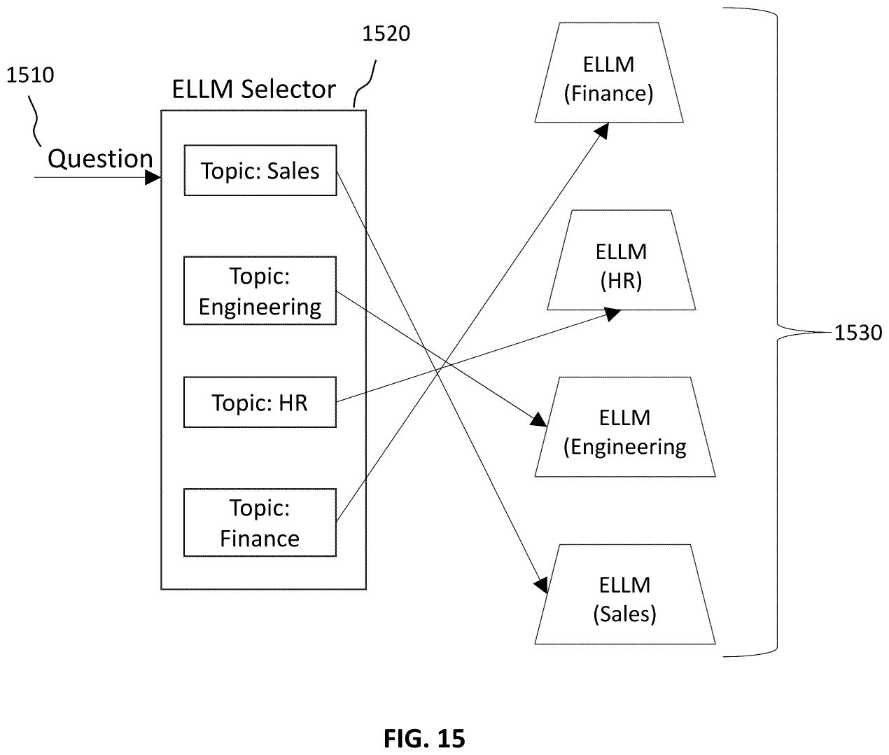

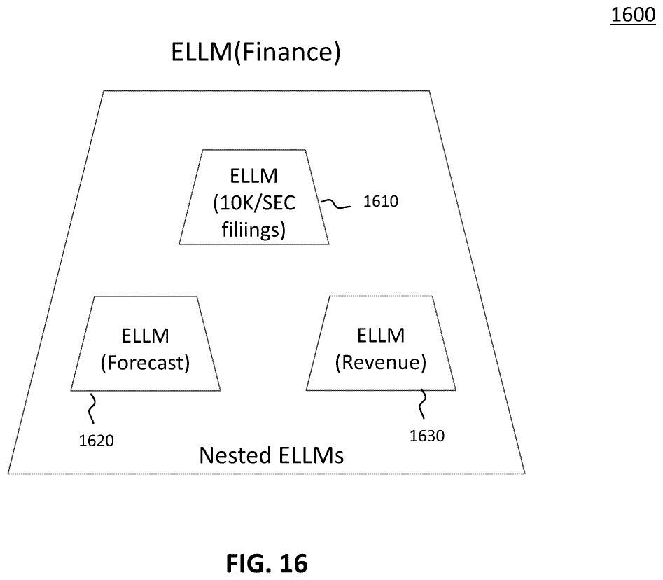

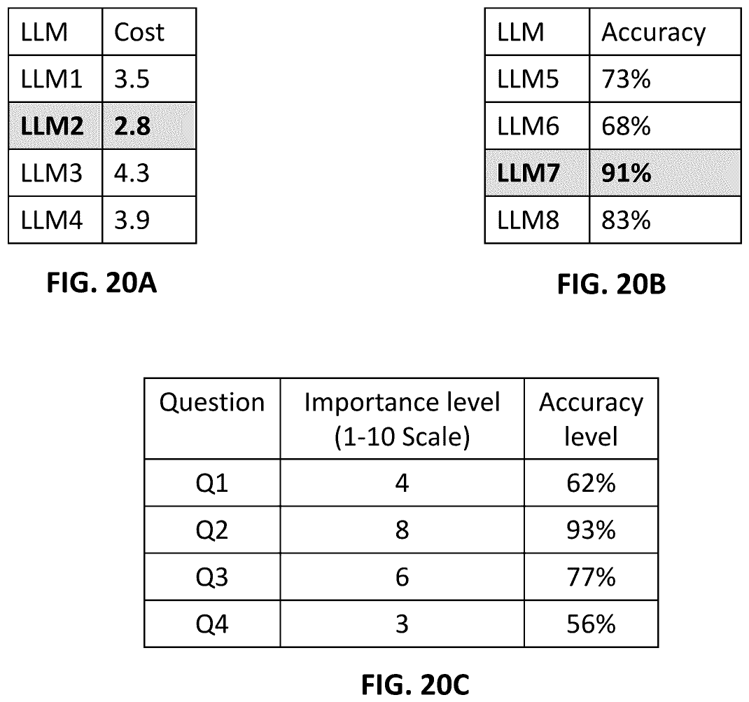

At block 320, in some embodiments, the control circuitry, such as the control circuitry 428 and/or 420 of system 400 in FIG. 4, may generate K number of ELLMs using the training data generated. In doing so, the control circuitry 428 and/or 420 may use classified data that is curated for its quality to generate a plurality of ELLMs. Such ELLMs may be ELLMs that provide different tiers of access to content where such access is authorized based on the job level or title of an employee, as depicted in FIG. 14, ELLMs that are department specific, as depicted in FIG. 15, nested ELLMs that are further sub-categorized under a main category, as depicted in FIG. 16, ELLMs that are generated based on cost or accuracy basis as depicted in FIGS. 20A-C, ELLMs that are application specific, and other types of ELLMs that are discussed in the embodiments herein.

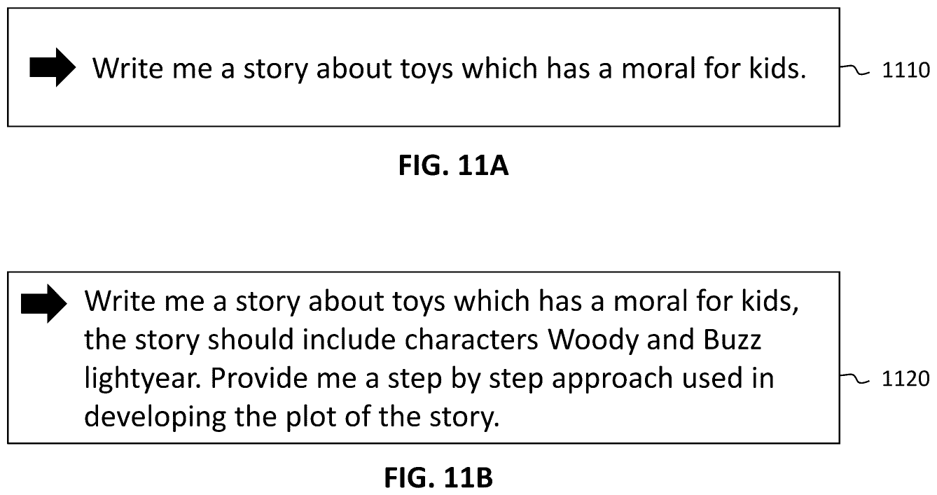

At block 330, the control circuitry 428 and/or 420 may receive a question from a user that seeks an answer. In some instances, the question may be a simple question with a single ask and in other embodiments the question may be a multipart or complex question that may require multiple answers or answers that are based on multiple factors. In some embodiments, the question may simply seek an answer and in other embodiments the question may seek an answer as well as the reasoning and steps taken to get to the answer. Some examples of types of questions that may be received by the control circuitry 428 and/or 420 are displayed in FIGS. 11A and 11B.

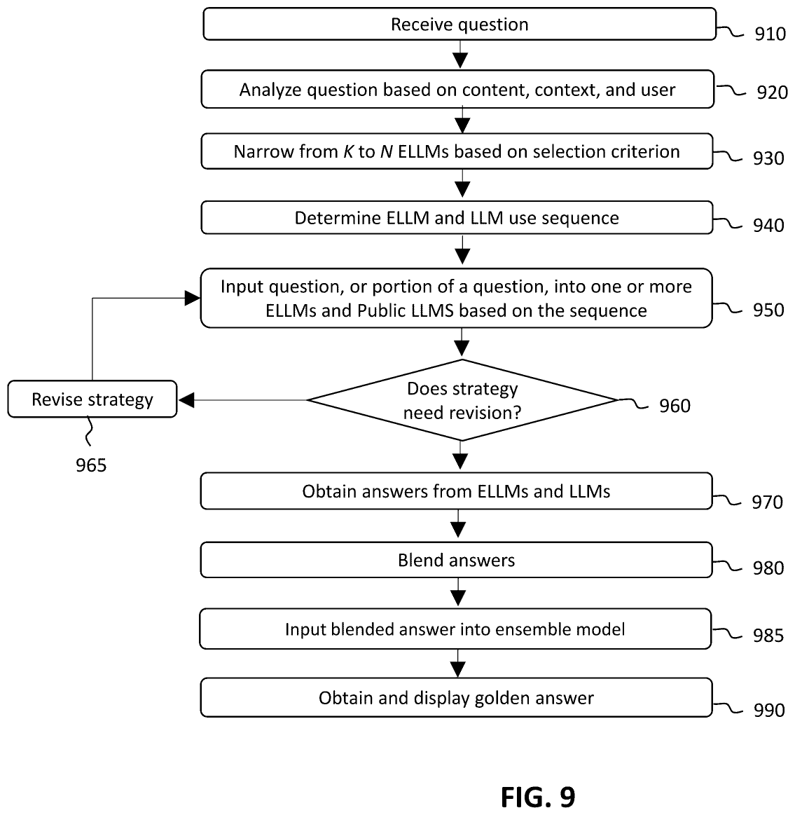

At block 340, upon receiving the question, the control circuitry 428 and/or 420 may strategically select a combination of ELLMs and/or public LLMs, use the strategically selected combination of ELLMs and/or public LLMs to answer the question, blend the answers based on various criterion, and then perform an ensemble technique to obtain a curated answer to the question. Additional details of the process are described in the description related to FIGS. 9-10, and 12-20.

At block 350, the curated answer, also referred to herein as the golden answer, may then be displayed to the user from whom the question was received on their electronic device. Since the user may be using a user interface to input the question, the answer may be displayed on the display of the same user interface. In other embodiments, the user may provide instruction on which device to receive the answer. For example, in one embodiment, the user may instruct the control circuitry to text them the answer on their mobile phone. In another embodiment, if the user is a manager or a supervisor in a company, the user may identify a plurality of employees that should receive the answer. In another embodiment, user may instruct certain portions of the answer to be transmitted to one person or department and another portion of the answer to be transmitted to a different person or department in the company, such as based on the relevance of the answer to the person. The user may also set up rules on how the answer is to delivered, to whom, and when, and the format in which the answer is to be delivered.

FIG. 4 is a block diagram of an example of a system for generating and training federated large language models (LLMs) and combining and using them in an enterprise context, in accordance with some embodiments of the disclosure and FIG. 5 is a block diagram of an example of an electronic device used for entering commands or queries, executing functions relating to generating, training, combining and using LLMs, and displaying answers provided by LLMs in a user interface, in accordance with some embodiments of the disclosure.

FIGS. 4 and 5 also describe exemplary devices, systems, servers, and related hardware that may be used to implement processes, functions, elements and components, and functionalities described in relation to FIGS. 3 and 6-20C. Further, FIGS. 4 and 5 may also be used obtain enterprise data from a plurality of enterprise resources, classify and curate the obtained data, such as based on data quality and data type, generate training data from the classified and curated data, and use the training data to generate a plurality of contextually distinguished ELLMs. FIGS. 4 and 5 may also be used to associate the training data with one or more enterprise functions and department, associate the training data with different level of access, including different levels of authorization for different employees of an enterprise, such as based on the confidential and proprietary nature of the training data, consider and evaluate one or more enterprise functions and departments and the level of access/authorization based on such consideration and evaluation to generate contextually distinguished ELLMs, including separately generating ELLMs different ELLMs that have been trained with a higher tier of confidential data from an ELLM that have been trained with data with a lower tier of confidentiality. FIGS. 4 and 5 may also be used to selectively combine one or more generated ELLMs, as well as any publicly available LLMs, where the combinations of ELLMs and LLMs are selected based on both the identity of the user as well as the context of the question and using the selected combination of ELLMs and LLMs to process a question inputted by a user. FIGS. 4 and 5 may also be used to obtain one or more answer by processing the question via the combination of ELLMs and LLMs and blending the answers to then use them as input in an ensemble model to obtain a final answer. FIGS. 4 and 5 may also be used for automatically determining various combinations or ELLMs and LLMs to use, to determine a sequence of their use, revise the sequence based on answers received from user LLMs and ELLMs, and generate one or more answers to queries that take into account the identity of the user as well as the content and context of the question.

In some embodiments, one or more parts of, or the entirety of system 400, may be configured as a system implementing various features, processes, functionalities and components of FIGS. 3 and 6-20C. Although FIG. 4 shows a certain number of components, in various examples, system 400 may include fewer than the illustrated number of components and/or multiples of one or more of the illustrated number of components.

System 400 is shown to include a computing device 418, a server 402 and a communication network 414. It is understood that while a single instance of a component may be shown and described relative to FIG. 4, additional instances of the component may be employed. For example, server 402 may include, or may be incorporated in, more than one server. Similarly, communication network 414 may include, or may be incorporated in, more than one communication network. Server 402 is shown communicatively coupled to computing device 418 through communication network 414. While not shown in FIG. 4, server 402 may be directly communicatively coupled to computing device 418, for example, in a system absent or bypassing communication network 414.

Communication network 414 may comprise one or more network systems, such as, without limitation, an internet, LAN, WIFI or other network systems suitable for audio processing applications. In some embodiments, system 400 excludes server 402, and functionality that would otherwise be implemented by server 402 is instead implemented by other components of system 400, such as one or more components of communication network 414. In still other embodiments, server 402 works in conjunction with one or more components of communication network 414 to implement certain functionality described herein in a distributed or cooperative manner. Similarly, in some embodiments, system 400 excludes computing device 418, and functionality that would otherwise be implemented by computing device 418 is instead implemented by other components of system 400, such as one or more components of communication network 414 or server 402 or a combination. In still other embodiments, computing device 418 works in conjunction with one or more components of communication network 414 or server 402 to implement certain functionality described herein in a distributed or cooperative manner.

Computing device 418 includes control circuitry 428, display 434 and input circuitry 416. Control circuitry 428 in turn includes transceiver circuitry 462, storage 438 and processing circuitry 440. In some embodiments, computing device 418 or control circuitry 428 may be configured as media device 500 of FIG. 5.

Server 402 includes control circuitry 420 and storage 424. Each of storages 424 and 438 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, solid state devices, quantum storage devices, gaming consoles, gaming media, or any other suitable fixed or removable storage devices, and/or any combination of the same. Each storage 424, 438 may be used to store various types of content, metadata, and or other types of data (e.g., they can be used to store ELLMs, user credentials, user profile and information, user association with different functions and departments within an enterprise, employee job titles and designations, contextual and content identifiers related to ELLMs to identify the type of content within each ELLM, input question, ensemble model, ELLM selection modules, cost and accuracy data associated with each ELLM and LLM, answers obtained via use of any combination of ELLMs and LLMs, golden answer, and machine learning data, and NLP, ML, and AI algorithms). Non-volatile memory may also be used (e.g., to launch a boot-up routine and other instructions). Cloud-based storage may be used to supplement storages 424, 438 or instead of storages 424, 438. In some embodiments, data relating to obtaining enterprise data from a plurality of enterprise resources, classifying and curating the obtained data, such as based on data quality and data type, generating training data from the classified and curated data, using the training data to generate a plurality of contextually distinguished ELLMs, associating the training data with one or more enterprise functions and department, associating the training data with different level of access, including different levels of authorization for different employees of an enterprise, such as based on the confidential and proprietary nature of the training data, considering and evaluating one or more enterprise functions and departments and the level of access/authorization based on such consideration and evaluation to generate contextually distinguished ELLMs, including separately generating ELLMs different ELLMs that have been trained with a higher tier of confidential data from an ELLM that have been trained with data with a lower tier of confidentiality, selectively combining one or more generated ELLMs, as well as any publicly available LLMs, where the combinations of ELLMs and LLMs are selected based on both the identity of the user as well as the context of the question and using the selected combination of ELLMs and LLMs to process a question inputted by a user, obtaining one or more answer by processing the question via the combination of ELLMs and LLMs and blending the answers to then use them as input in an ensemble model to obtain a final answer, and data relating to all other processes and features described herein, may be recorded and stored in one or more of storages 412, 438.

In some embodiments, control circuitry 420 and/or 428 executes instructions for an application stored in memory (e.g., storage 424 and/or storage 438). Specifically, control circuitry 420 and/or 428 may be instructed by the application to perform the functions discussed herein. In some implementations, any action performed by control circuitry 420 and/or 428 may be based on instructions received from the application. For example, the application may be implemented as software or a set of executable instructions that may be stored in storage 424 and/or 438 and executed by control circuitry 420 and/or 428. In some embodiments, the application may be a client/server application where only a client application resides on computing device 418, and a server application resides on server 402.

The application may be implemented using any suitable architecture. For example, it may be a stand-alone application wholly implemented on computing device 418. In such an approach, instructions for the application are stored locally (e.g., in storage 438), and data for use by the application is downloaded on a periodic basis (e.g., from an out-of-band feed, from an internet resource, or using another suitable approach). Control circuitry 428 may retrieve instructions for the application from storage 438 and process the instructions to perform the functionality described herein. Based on the processed instructions, control circuitry 428 may determine a type of action to perform in response to input received from input circuitry 416 or from communication network 414. For example, in response to determining that the user who has inputted the query in the prompt is an employee, the question relates to enterprise finance, and that the employee has authorization to receive confidential data that is below a level 6 (on a 1-10 scale where 10 may be the most confidential date), then automatically determining a strategy to use a combination of ELLMs that are finance related and include confidential data below the level 6. To accomplish this, in one embodiment, the control circuitry 428 may perform the steps of process described at least in any one or more of FIGS. 3, 6-10, and 12 below and all the steps and processes described in all the figures depicted herein.

In client/server-based embodiments, control circuitry 428 may include communication circuitry suitable for communicating with an application server (e.g., server 402) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 414). In another example of a client/server-based application, control circuitry 428 runs a web browser that interprets web pages provided by a remote server (e.g., server 402). For example, the remote server may store the instructions for the application in a storage device. The remote server may process the stored instructions using circuitry (e.g., control circuitry 428) and/or generate displays. Computing device 418 may receive the displays generated by the remote server and may display the content of the displays locally via display 434. This way, the processing of the instructions is performed remotely (e.g., by server 402) while the resulting displays, such as the display windows described elsewhere herein, are provided locally on computing device 418. Computing device 418 may receive inputs from the user via input circuitry 416 and transmit those inputs to the remote server for processing and generating the corresponding displays. Alternatively, computing device 418 may receive inputs from the user via input circuitry 416 and process and display the received inputs locally, by control circuitry 428 and display 434, respectively.

Server 402 and computing device 418 may transmit and receive content and data such as user data and user credentials, user profile, data related to user association with different functions and departments within an enterprise, data related to employee job titles and designations, training data for ELLMs, cost and accuracy data associated with each ELLM and LLM, and input from electronic devices, such as input queries and prompts. Control circuitry 420, 428 may send and receive commands, requests, and other suitable data through communication network 414 using transceiver circuitry 460, 462, respectively. Control circuitry 420, 428 may communicate directly with each other using transceiver circuits 460, 462, respectively, avoiding communication network 414.

It is understood that computing device 418 is not limited to the embodiments and methods shown and described herein. In nonlimiting examples, computing device 418 may be a personal computer (PC), a laptop computer, a tablet computer, a WebTV box, a personal computer television (PC/TV), a PC media server, a PC media center, a handheld computer, a mobile telephone, a smartphone, or any other device, computing equipment, or wireless device, and/or combination thereof that can process input questions, use various combinations of LLM and ELLM models, and generate an answer.

Control circuitry 420 and/or 418 may be based on any suitable processing circuitry such as processing circuitry 426 and/or 440, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitry 420 and/or control circuitry 418 are configured to obtain enterprise data from a plurality of enterprise resources, classify and curate the obtained data, such as based on data quality and data type, generate training data from the classified and curated data, and use the training data to generate a plurality of contextually distinguished ELLMs. Control circuitry 420 and/or control circuitry 418 are also configured to associate the training data with one or more enterprise functions and department, associate the training data with different level of access, including different levels of authorization for different employees of an enterprise, such as based on the confidential and proprietary nature of the training data, consider and evaluate one or more enterprise functions and departments and the level of access/authorization based on such consideration and evaluation to generate contextually distinguished ELLMs, including separately generating ELLMs different ELLMs that have been trained with a higher tier of confidential data from an ELLM that have been trained with data with a lower tier of confidentiality. Control circuitry 420 and/or control circuitry 418 are also configured to selectively combine one or more generated ELLMs, as well as any publicly available LLMs, where the combinations of ELLMs and LLMs are selected based on both the identity of the user as well as the context of the question and using the selected combination of ELLMs and LLMs to process a question inputted by a user. Control circuitry 420 and/or control circuitry 418 are also configured to obtain one or more answer by processing the question via the combination of ELLMs and LLMs and blending the answers to then use them as input in an ensemble model to obtain a final answer. Control circuitry 420 and/or control circuitry 418 are also configured to automatically determining various combinations or ELLMs and LLMs to use, to determine a sequence of their use, revise the sequence based on answers received from LLMs and/or ELLMs, and generate one or more answers to queries that take into account the identity of the user as well as the content and context of the question and perform all processes described and shown in connection with FIGS. 3, 6-10, and 12.

Computing device 418 receives a user input 404 at input circuitry 416. For example, computing device 418 may receive a user input like a question, query, or task to answer a math question, to perform algorithm testing to detect any bugs, determine financial projections for an enterprise, etc.

Transmission of user input 404 to computing device 418 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, or any other suitable wireless transmission protocol. Input circuitry 416 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, or other wireless transmission protocols.

Processing circuitry 440 may receive input 404 from input circuit 416. Processing circuitry 440 may convert or translate the received user input 404 that may be in the form of voice input into a microphone. In some embodiments, input circuit 416 performs the translation to digital signals. In some embodiments, processing circuitry 440 (or processing circuitry 426, as the case may be) carries out disclosed processes and methods. For example, processing circuitry 440 or processing circuitry 426 may perform processes as described in FIGS. 3, 6-10, and 12, respectively.

FIG. 5 is a block diagram of an example of an electronic device 500 used for entering commands or queries, executing functions relating to generating, training, combining and using LLMs, and displaying answers provided by LLMs in a user interface, in accordance with some embodiments of the disclosure. In an embodiment, the equipment device 500, is the same equipment device 402 of FIG. 4. The equipment device 500 may receive content and data via input/output (I/O) path 502. The I/O path 502 may provide audio content (e.g., broadcast programming, on-demand programming, internet content, content available over a local area network (LAN) or wide area network (WAN), and/or other content) and data to control circuitry 504, which includes processing circuitry 506 and a storage 508. The control circuitry 504 may be used to send and receive commands, requests, and other suitable data using the I/O path 502. The I/O path 502 may connect the control circuitry 504 (and specifically the processing circuitry 506) to one or more communications paths. I/O functions may be provided by one or more of these communications paths but are shown as a single path in FIG. 5 to avoid overcomplicating the drawing.

The control circuitry 504 may be based on any suitable processing circuitry such as the processing circuitry 506. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

The processes as described herein may be implemented in or supported by any suitable software, hardware, or combination thereof. They may also be implemented on user equipment, on remote servers, or across both.

In client-server-based embodiments, the control circuitry 504 may include communications circuitry suitable for allowing communications between two separate user devices to obtain enterprise data from a plurality of enterprise resources, classify and curate the obtained data, such as based on data quality and data type, generate training data from the classified and curated data, and use the training data to generate a plurality of contextually distinguished ELLMs. The communications circuitry may also be configured to associate the training data with one or more enterprise functions and department, associate the training data with different level of access, including different levels of authorization for different employees of an enterprise, such as based on the confidential and proprietary nature of the training data, consider and evaluate one or more enterprise functions and departments and the level of access/authorization based on such consideration and evaluation to generate contextually distinguished ELLMs, including separately generating ELLMs different ELLMs that have been trained with a higher tier of confidential data from an ELLM that have been trained with data with a lower tier of confidentiality. The communications circuitry may also be configured to selectively combine one or more generated ELLMs, as well as any publicly available LLMs, where the combinations of ELLMs and LLMs are selected based on both the identity of the user as well as the context of the question and using the selected combination of ELLMs and LLMs to process a question inputted by a user. The communications circuitry may also be configured to obtain one or more answer by processing the question via the combination of ELLMs and LLMs and blending the answers to then use them as input in an ensemble model to obtain a final answer. The communications circuitry may also be configured to automatically determine various combinations or ELLMs and LLMs to use, to determine a sequence of their use, revise the sequence based on answers received from LLMs and/or ELLMs, and generate one or more answers to queries that take into account the identity of the user as well as the content and context of the question and perform all processes described and shown in connection with FIGS. 3, 6-10, and 12, and perform all related functions and processes as described herein. The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of electronic equipment devices, or communication of electronic equipment devices in locations remote from each other (described in more detail below).

Memory may be an electronic storage device provided as the storage 508 that is part of the control circuitry 504. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, gaming consoles, gaming media, or any other suitable fixed or removable storage devices, and/or any combination of the same. The storage 508 may be used to store ELLMs, user credentials, user profile and information, user association with different functions and departments within an enterprise, employee job titles and designations, contextual and content identifiers related to ELLMs to identify the type of content within each ELLM, input question, ensemble model, ELLM selection modules, cost and accuracy data associated with each ELLM and LLM, answers obtained via use of any combination of ELLMs and LLMs, golden answer, and machine learning data, and NLP, ML, and AI algorithms and all the functionalities and processes discussed herein. Cloud-based storage, described in relation to FIG. 5, may be used to supplement the storage 508 or instead of the storage 508.

The control circuitry 504 may include audio generating circuitry and tuning circuitry, such as one or more analog tuners, audio generation circuitry, filters or any other suitable tuning or audio circuits or combinations of such circuits. The control circuitry 504 may also include scaler circuitry for upconverting and down converting content into the preferred output format of the electronic device 500. The control circuitry 504 may also include digital-to-analog converter circuitry and analog-to-digital converter circuitry for converting between digital and analog signals. The tuning and encoding circuitry may be used by the electronic device 500 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 508 is provided as a separate device from the electronic device 500, the tuning and encoding circuitry (including multiple tuners) may be associated with the storage 508.

The user may utter instructions to the control circuitry 504, which are received by the microphone 516. The microphone 516 may be any microphone (or microphones) capable of detecting human speech. The microphone 516 is connected to the processing circuitry 506 to transmit detected voice commands and other speech thereto for processing. In some embodiments, voice assistants (e.g., Siri, Alexa, Google Home and similar such voice assistants) receive and process the voice commands and other speech.

The electronic device 500 may include an interface 510. The interface 510 may be any suitable user interface, such as a remote control, mouse, trackball, keypad, keyboard, touch screen, touchpad, stylus input, joystick, or other user input interfaces. A display 512 may be provided as a stand-alone device or integrated with other elements of the electronic device 500. For example, the display 512 may be a touchscreen or touch-sensitive display. In such circumstances, the interface 510 may be integrated with or combined with the microphone 516. When the interface 510 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the display 512 may be a 3D display. The speaker (or speakers) 514 may be provided as integrated with other elements of electronic device 500 or may be a stand-alone unit. In some embodiments, the display 512 may be outputted through speaker 514.

The equipment device 500 of FIG. 5 can be implemented in system 400 of FIG. 4 as electronic equipment device 402, but any other type of user equipment suitable for allowing communications between two separate user devices for performing the functions related to implementing machine learning (ML) and artificial intelligence (AI) algorithms, and all the functionalities discussed associated with the figures mentioned in this application

The electronic device 500 of any other type of suitable user equipment suitable may also be used to implement ML and AI algorithms, and related functions and processes as described herein. Various network configurations of devices may be implemented and are discussed in more detail below.

FIG. 6 is flowchart of an example of a process for obtaining enterprise data and generating and training enterprise LLMs, in accordance with some embodiments of the disclosure.

The process 600 may be implemented, in whole or in part, by systems or devices such as those shown in FIGS. 4-5. One or more actions of the process 600 may be incorporated into or combined with one or more actions of any other process or embodiments described herein. The process 600 may be saved to a memory or storage (e.g., any one of those depicted in FIGS. 4-5) as one or more instructions or routines that may be executed by a corresponding device or system to implement the method 600.

In some embodiments, at block 610, the control circuitry, such as the control circuitry 428 and/or 420 of system 400 in FIG. 4, may access enterprise data to obtain and analyze the enterprise data and use it as training data for an ELLM.

In some embodiments, the control circuitry 428 and/or 420 may access various private databases within the enterprise to obtain the data. Since enterprises may store data centrally at a server or another central storage device, and may store data specific to a department, such as human resources, at a specific server or human resources storage device, the control circuitry 428 and/or 420 may access all central, local, and department specific databases, servers, storage devices and any other libraries in which data is stored.

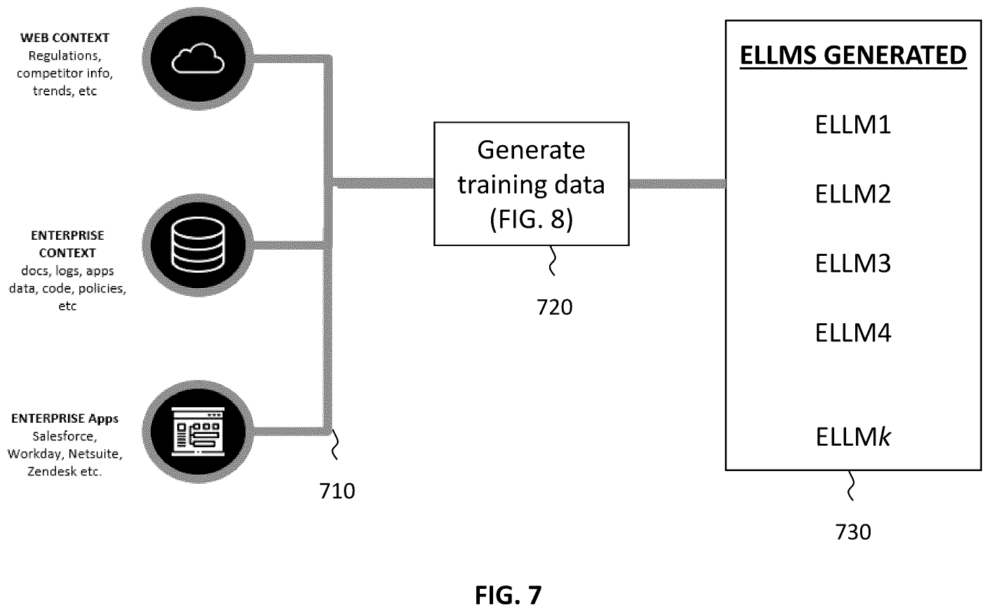

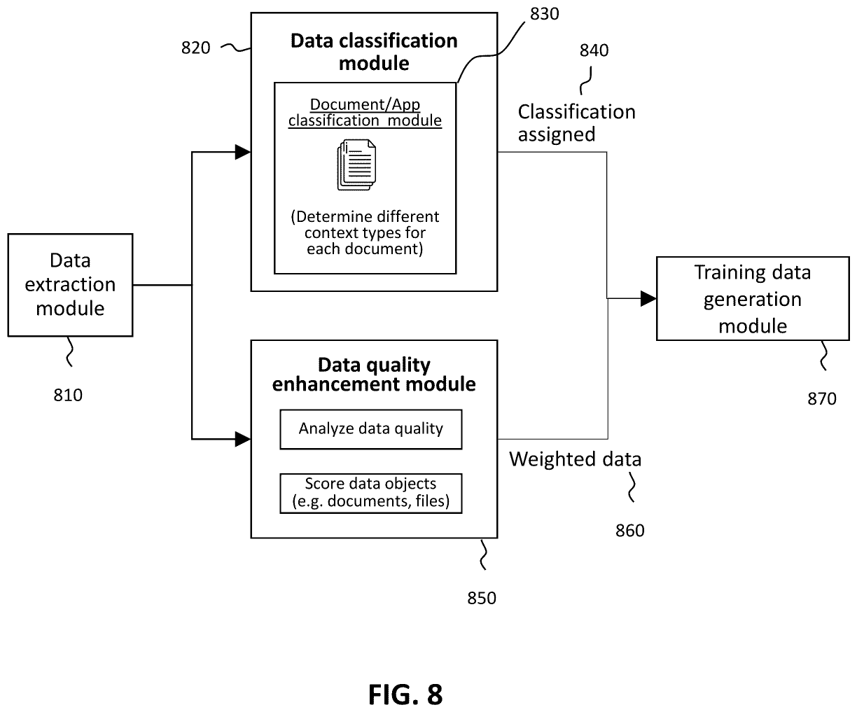

In some embodiments, data may be stored within applications, such as Salesforce's desk.com™ application that offers a help desk ticketing related solution or Oracle's NetSuite™ that allows businesses to gain customer insights. The application may be sales related or they may be marketing, engineering, facilities, management, or finance related. In some instances, the application may be solely used by a single department at the company and in other instances the application may be used by multiple departments. Applications may also include a plurality of features, some of which may be used by one department and other features may be used by another department. In yet other embodiments, data, such as web context data may be stored in the cloud (e.g., public or private cloud). Examples of such data may include regulations, competitor information, etc. Enterprise context data, such as documents, logs, applications, code, policies, employee profiles, employee job titles and roles, employee performance reviews, conference call recordings, etc. may be stored in servers, databases, platforms, storage devices. Data relating to enterprise applications, may also be stored at servers, databases, platforms, storage devices. Although some examples are described where enterprise data may be stored, these examples are non-limiting and data may be found and stored in numerous locations and servers, databases, platforms, storage devices, and on online platforms. All such data may be accessed by the control circuitry to obtain, analyze, curate for quality, classify and use it as training data for an ELLM. Additional examples of enterprise resources from where data can be accessed are provided in FIGS. 7-8.

In some embodiments, the control circuitry 428 and/or 420 may require authorization to access the data. As such, a determination may be made at block 620 if such an authorization is needed. Since some databases, servers, storage devices in the enterprise may store confidential, proprietary, and even top company secrets, it may not be desirable to provide access to all the data for use in training an ELLM. In other embodiments, access may be provided to all the data, however, as will be described in further detail below, access may be restricted depending on which user is asking the question or which user seeks information and what level of clearance is allotted for that particular user.

If a determination is made at block 620 that an authorization is needed, then at block 625, authorization may be requested and obtained. If authorization is denied, then the control circuitry 428 and/or 420 may not be able to access and use data from such databases or storage devices and the control circuitry 428 and/or 420 may skip and move on to other servers, database, storage devices and the like to access and use enterprise data.

At block 630, the control circuitry 428 and/or 420 may extract data from all the servers, such as email server, department servers, executable applications, document libraries, databases, employee files stored on local or shared drives, and any storage used by the enterprise or an employee of the enterprise for storing data for which authorization is provided. Extracting data may be performed by the control circuitry by using existing techniques such as extract, transform, and load (ETL) techniques and extract, load, transform (ELT) techniques. Data may also be extracted by the control circuitry by using crawlers, scraping software tools, API integration, data mining, database querying, text pattern matching and other types of large data extraction techniques. Data may also be obtained from other existing LLMs and ELLMs.

At block 640, the data accessed may be classified into categories. In some embodiments, data may relate to human resources or marketing departments and it may be classified as such based on the context. In other embodiments, data may relate to multiple departments and accordingly it may be classified into multiple classes. For example, financials relating to a product may be relevant to sales, marketing, and finance departments. As such, financials may be categorized for all departments that may utilize the data. Data classification may include classes, subclasses, and further subclasses. There may be various tiers of classes and subclasses depending on the applicability and use of such data. The process of classifying data is further described in the description of FIGS. 7-8.

At block 650, a determination may be made whether a data object, such a document, file, application, image, video, etc., has multiple sections relating to different context. For example, an internal company report may provide details relating to several departments in a company. In such a scenario, in one embodiment, the entire document may be classified for all the department that are addressed in the company report. In another embodiment, as depicted at block 655, each section of the document may receive a different classification depending on its relationship and applicability to a department. The control circuitry 428 and/or 420 may analyze data objects section by section, part by part, or segment by segment, to classify each section, part, segment according to their context. The control circuitry 428 and/or 420 may use a general classification for data objects that apply to several departments of a company. The process of classifying data into classes and subclasses is further described in the description of FIGS. 7-8.

At block 660, the control circuitry 428 and/or 420 may determine data quality of the data extracted at block 630. Determining data quality may include the control circuitry 428 and/or 420 analyzing each data object based on one or more factors. The factors used may include, validity, versions, draft vs final, errors, comments associated with the data object, whether its used commonly, whether the data object resides in personal files of enterprise databases, document updating policies, and references by C-suite to name a few. These and other factors used by the control circuitry 428 and/or 420 to analyze data quality of a data object and generate a weighted score for the data object is discussed further at blocks 850 and 860 of FIG. 8.

At block 670, once the data has been classified and curated for quality, such data may be used by the control circuitry 428 and/or 420 to generate K number of ELLMs. This number may vary by the enterprise and the amount of data and classes. For example, some enterprises may have 10 ELLMs while others may have 5,000 ELLMs. The enterprise may also provide a predetermined limit to a number of ELLMs that are to be created and such limitations may be followed in creating the ELLMs. The generated ELLMs may then be trained at block 680 using the classified and quality curated data. Training the ELLMs may be a continuous process where new data generated is accessed, classified, curated and then added to train the generate ELLMs. In other embodiments, the training updates may be on a periodic basis instead of on a continuous basis. Other rules for accessing additional data and using it to train the generated ELLMs may also be applied.

FIG. 7 is a block diagram of an example of using enterprise data to generated federated enterprise LLMs, in accordance with some embodiments of the disclosure.

In some embodiments, enterprise resources 710 may be accessed by the control circuitry 428 and/or 420 to obtain data that can be classified and curated to generate training data 720. The training data may then be used to train a plurality of ELLMs 730. The enterprise resources 710, in some embodiments, may include enterprise cloud, enterprise databases, servers, such as email server, department servers, executable applications, document libraries, employee storage, such as local storage drives or shared drives, software-defined storage, and/or storage area networks. Enterprise resources may be located at the company location or may also be at third party locations. For example, enterprise resources may also be third party services used by the enterprise to securely and privately store data and use on-demand cloud computing platforms, such as Amazon Web Services “AWS”™. An enterprise may also securely and privately store data in various web applications such as Google drive™, Box™, Dropbox™ and other such related platforms.

The data stored in such resources may be data that has a web context, such as regulations, competitor information, pricing trends, etc. It may also be data that has an enterprise context, such as enterprise related documents, logs, applications, code, policies, employee profiles, employee job titles and roles, employee performance reviews, conference call recordings, meeting schedules and agenda, internal meeting minutes, sales or marketing practices, business strategies, company's roadmaps, etc. The data stored may also be applications, such as salesforce, workday, NetSuite, Zendesk, design tools, conferencing tools, development tools, data analysis applications, financial reporting and bookkeeping applications, tax and accounting applications, business intelligence applications, payroll applications, and customer service applications.

In some embodiments, to use the data accessed and obtained from enterprise resources all other enterprise storage locations for generating training data 720, the control circuitry 428 and/or 420 may invoke data classification and data quality enhancement modules as depicted in FIG. 8. In some embodiments, enterprise data that has undergone the classification has quality curation process may be used as training data for training the ELLMs, as will be described in further detail in FIG. 8. As depicted in FIG. 7, a plurality of federated ELLMs, such as k ELLMs may be generated based on the analysis of the training data. For example, the analysis of data accessed may result in a determination that there are k number of classes of data in the enterprise. Accordingly, the same number of ELLMs may be generated such that each ELLMs is specific to a class of data. In other embodiments, the control circuitry 428 and/or 420 may generate broad category ELLMs such that data that relates to the broad category may be used to train such ELLMS. Yet in other embodiments, control circuitry 428 and/or 420 may generate that are department specific, application specific, or job role specific. Nested ELLMs that sub-categorized under a main category ELLM may also be generated. The control circuitry 428 and/or 420 may also determine a predetermined number for the total number of ELLMs that are to be generated or use a formula or a recommendation engine to determine the number of ELLMs to generate.

FIG. 8 is a block diagram of an example for determining data classification and curating data quality for its use to train an enterprise LLM, in accordance with some embodiments of the disclosure.

In some embodiments, a system for generating training data, such as the system 400 in FIG. 4, may further include a data extraction module 810, a data classification module 820, a data quality enhancement module 850, and a training data module 870. In some embodiments, the modules may be separate from each other and in other embodiments a single module may be able to perform all the functions performed by each of the mentioned modules. Although some examples of modules have been described, the embodiment are not so limited and any other type of module, or less and more modules, may also be used to perform similar functions as described in FIG. 8.

In some embodiments, the data extraction module 810 may be invoked by the control circuitry 428 and/or 420 to extract data from enterprise resources and data storage locations, such as the enterprise resources 710 described in FIG. 7.

The data extraction module 810 once invoked, may extract data from all enterprise resources and data storage locations, such as enterprise servers, such as email server, department servers, executable applications, document libraries, databases, employee files stored on local or shared drives, and any storage used by the enterprise or an employee of the enterprise for storing data. The data extraction module may use techniques such as extract, transform, and load (ETL) techniques and extract, load, transform (ELT) techniques to extract date from the enterprise resources and storage locations. It may also use crawlers, scraping software tools, API integration, data mining, database querying, text pattern matching and other types of large data extraction techniques to extract data from all enterprise resources and data storage locations used by the enterprise, including from other existing ELLMs.

Once data has been accessed, extracted or obtained, the data classification module 820 may be invoked to classify the extracted data. In other words, the data classification module 820 may organize the extracted data into classes and subclasses. The data classification module may further classify data into several tiers of classes and nested subclasses within a broader class. To classify the extracted data, the data classification module may tag the extracted data to make it easily searchable and trackable. The tagging may be based on the type of data, its relevance to a particular department, its sensitivity, its business value, etc. Tagging may also be implemented based on other desired factors or recommendations, such as a specific category of data that the company wants easy access to for performing a critical company function. Tagging may be automatic without any user intervention and in other embodiment it may be user assisted or supervised.

The data classification module 820 may review each piece of data extracted from by the extraction module 810 and determine its context and applicability. For example, if a document includes employment details, or is a document that is an employee handbook, employee vacation policy, employee review, employee compensation, etc., then analyzing the content and the context the data classification module 820 may determine that it should be classified as a human resources document. As such, a human resources or HR tag may be added to that piece of data. The data classification module 820 may further determine that even within HR, employee compensation should be classified as its own category since that is used specifically for hiring and retention and may be used by a specific group within HR. If such a sub-classification is useful within the enterprise, then the data classification module 820 may generate a tag for such a nested sub-class.

Organizing data into such classes and sub-classes, including layers of nested tiers and classes, may make data easier to locate and retrieve, especially data that is very specific or niche and is of particular importance to answer certain questions. Such classification may also provide full visibility into the various classes of data included in the enterprise.

The data classification module 820 may also use existing classification techniques to classify the extracted data. For example, the data classification module 820 may use a supervised machine learning method to determine an appropriate tag of a data object extracted. The supervised machine learning method may be trained to analyze data and suggest a classification tag which then may be approved, denied, or modified as needed.

In some embodiments, each data object, such as a document, email, text message, audio file, video file, image, application, file, or any other type of data object in its entirety may be tagged with a single classification. In other embodiments, the data object may relate to. multiple departments, functions, applications within the enterprise and as such may be tagged with multiple classifications or sub-classifications.

In other embodiments, data objects, such a document, file, application, image, video, etc., may have multiple sections which have different content and context. As such, each section may be analyzed by a document/app classification module 830 that is associated with the data classification module 820 and each section may receive a separate classification. In such an embodiment, the overall data object in its entirety, such as a word document, may receive a certain classification and sections within the document may receive different classifications. As depicted at block 840, the data classification module 820, may assign the classification and/or sub-classification to each data object that is associated with the enterprise and is extracted by the data extraction module 810.

Once data has been accessed, extracted or obtained by the data extraction module 810, the data quality enhancement module 850 may be invoked to curate data quality. Ensuring that enterprise data extracted by the data extraction module 810 is of good quality, high quality, reliable, and complete and accurate may be of high importance to an enterprise. This is because the extracted data may be used to generate and train ELLMs that essentially may be used to make key business decisions, maintain market leadership by staying ahead of competition, make day-to-day decision in a department, or used for any business purpose. As such, curating data it for its quality ensures that accurate, reliable, and complete data that is not outdated is being used by the enterprise and its employees when using ELLMs that are trained on such data to obtain answers relating to their work and the enterprise.

Accordingly, the data quality enhancement module 850 may analyze data quality and score each data object (e.g., document, email, text message, audio file, video file, image, application, file) according to its quality. The process of analyzing may include the data quality enhancement module 850 analyzing each data object based on one or more factors. The factors used may include, validity, versions, draft vs final, errors, comments associated with the data object, whether it's used commonly, whether the data object resides in personal files of enterprise databases, document updating policies, and references by C-suite to name a few.

Data objects may be weighed against these and other factors and a weighted score for each data object may be generated. For example, in one embodiment, in terms of validity, a data object that has expired or is expiring soon may receive a lower weighted score than a data object of the same type that is current and has a longer expiration date. In another embodiment, a data object that is an older version or a draft version may receive a lower weighted score than a data object of the same type that is current or final version. In yet another embodiment, a data object, such as a document, that has error, redline markups, editing comments, may receive a lower weighted score than a similar document in which such redline comments and errors were fixed. In another embodiment, a data object that received praise, comments from managers or C-suite employees, such as great job, may receive a higher weighted score. In another embodiment, a data object that resides in an employee's personal folder may receive a lower weighted score than a data object of the same type that resides in an enterprise storage thereby increasing its authenticity and accuracy as its being used more widely by other employees in the company. Although some embodiments of analyzing data quality and generating a weighed score have been described, these embodiments are non-limiting and other types of data analysis to generate a weighted score is also contemplated. For example, the data quality enhancement module 850 may use a formula, or recommendation from an artificial intelligence (AI) engine to determine data quality of a data object and generate its weighted score, such as weighted score depicted at block 860.

Once data has been classified, as depicted at blocks 820-840, and curated for quality and scored, as depicted at blocks 850 and 860, the data may then be used as training data by the training data generation module 870.

Once data has been classified and curated for quality, in some embodiments, the system, such as system 400, may use the data classifications generated at block 820-840 to generate ELLMs for each such classifications. In other embodiments, the system may generate ELLMs only for the top tier classes or the top tier and the first layer of subclasses and not for all the nested tiers. In yet other embodiments, all nested classification tiers may be used to generate a ELLM structure that mimics the class and sub-class nested tiers. In another embodiment, a predetermined number of ELLMs may be generated and in yet another embodiment, a formula or a recommendation from a recommendation engine, such as an AI engine, may be used to determine the number of ELLMs to generate. Each ELLM generated may then be trained using the data curated and scored by the data quality enhancement module 850. Training the ELLMs generated, such as the k number of ELLMs, would allow the ELLM to continuously, or at periodic intervals, learn and advance based on the continuous input of training data such that it stays current, accurate, relevant, and reliable in answering question posted to it. In some embodiments, the ELLMs described above may be generated and stored prior to receiving a question from user. In other embodiments, the ELLMs may be dynamically generated based on the training data 870 based on the identity of the user and the context of the question inputted.

FIG. 9 is flowchart of an example of a multi-layer process for selecting a plurality of ELLMs and/or LLMs to obtain a curated/enhanced answer, in accordance with some embodiments.

The process 900 may be implemented, in whole or in part, by systems or devices such as those shown in FIGS. 4-5. One or more actions of the process 900 may be incorporated into or combined with one or more actions of any other process or embodiments described herein. The process 900 may be saved to a memory or storage (e.g., any one of those depicted in FIGS. 4-5) as one or more instructions or routines that may be executed by a corresponding device or system to implement the method 900.

In some embodiments, a question is received at block 910. In some embodiments, the question may be a simple question with a single ask or query that may be inputted by a user in an input area on a user interface. Some examples of such a question with a single ask include: solve this problem, how much vacation time have I accrued to date, provide me copy of a vendor contract used by the enterprise for buying XYZ, write me code in python to perform task XYZ etc. One example of a single ask question is depicted in FIG. 11A.

In other embodiments, the question may be a multipart or complex question that may require multiple answers or answers that are based on multiple factors. Some formats of such a question with multiple parts include: explain to me how this problem was solved in the past and apply the solution to my current problem; write me code for XYZ and provide me steps and reasoning why each routine in the code was used, calculate our current revenue and based on current enterprise performance generate a projection for next quarter, obtain data from these two separate departments and provide me an answer that is personalized and suitable for the selected two departments. All such questions may have multiple parts, are complex, or require the ELLM to use the instructions provided in answering the question.

Yet another type of question inputted may provide several facts and ask the ELLM to use the facts in answering the question. Questions asked may relate entirely to the working of the enterprise or may relate to both working of the enterprise as well as standard principles and publicly available information.

Questions may be asked by any employee of the enterprise ranging from blue collar workers to the CEO. In some embodiments, employees may ask questions to the ELLMs in order to obtain an answer that will help them in their work at the enterprise.

At block 920, the control circuitry 428 and/or 420 may analyze the content and/or context of the question as well as the user that asked the question. With respect to content and/or context of the question, the results obtained from analyzing the content and/or context of the question may be used to determine which ELLM to use. The control circuitry 428 and/or 420 may use the results from the analysis to determine which ELLM has been trained with data that is relevant to the content and/or context of the question. For example, a question may relate to testing, design, or manufacturing. Based on the question, a determination may be made that the question likely relates to engineering. The control circuitry 428 and/or 420 may then search ELLMs to determine if an ELLM that has be trained with engineering data exists. If such an engineering related ELLM does exists, then the control circuitry 428 and/or 420 may select the ELLM trained with engineering data, as at least one of the ELLMs selected, to answer the question. In some instances, the determination may be made that the question likely relates to multiple departments as such ELLMs from multiple departments trained with data from such departments may be used.

Analyzing the question may, in some embodiments, involve using natural language processing (NLP) techniques. The system may use the NLP technique to obtain an understanding of the entered text or voice note. For example, if the question was entered by using voice recognition methods, such as voice to text, NLP techniques may used to understand the content and context of the question. NLP techniques may also be used in conjunction with other tools, such as sentiment analysis tools, to capture the sentiment and mood of the user when asking the question. For example, a frustrated or angry customer service user may be may be provided with different answer than a user that is experiencing the problem first time and just needs a solution.

The question may also be analyzed using artificial intelligence (AI) and machine learning (ML) engines that executive AI and ML algorithms. Such engines and algorithms may provide recommendations based on the question, such as what the question is really seeking, what class or subclass the question fall under, or what enterprise departments are more relevant to the content and context of the question.

The analysis with respect to user may include determining the user's credentials, such as name, employee number, etc., the user's job title, responsibilities, deliverables, their level of authorization to access information, what can and cannot be disclosed to the user, user preferences, and any and all details of the user that can be used in process 900 to determine the best or most appropriate ELLM for the user. The analysis with respect to user may also include the user's educational level, their proficiency in a topic, level of experience in a department of the enterprise, tenure with the department, their previous positions in the company, and their job-related interactions with other employees from other departments in the company. All such details may also be used in process 900 to determine the best or most appropriate ELLM for the user.

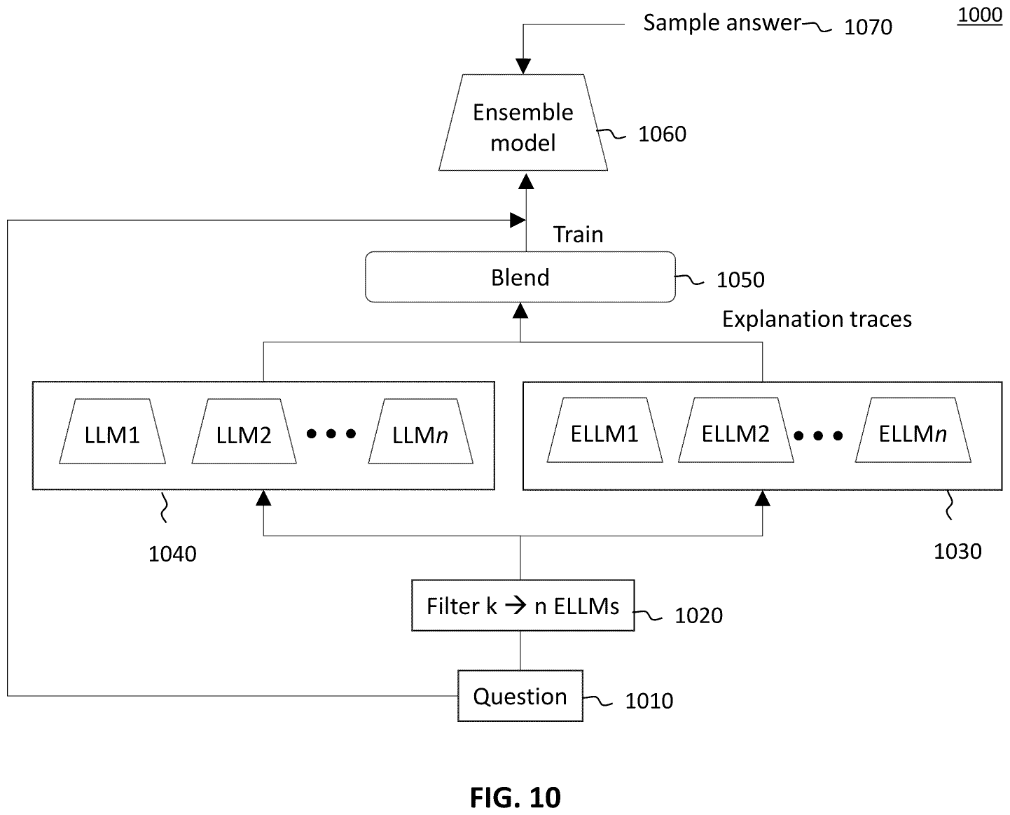

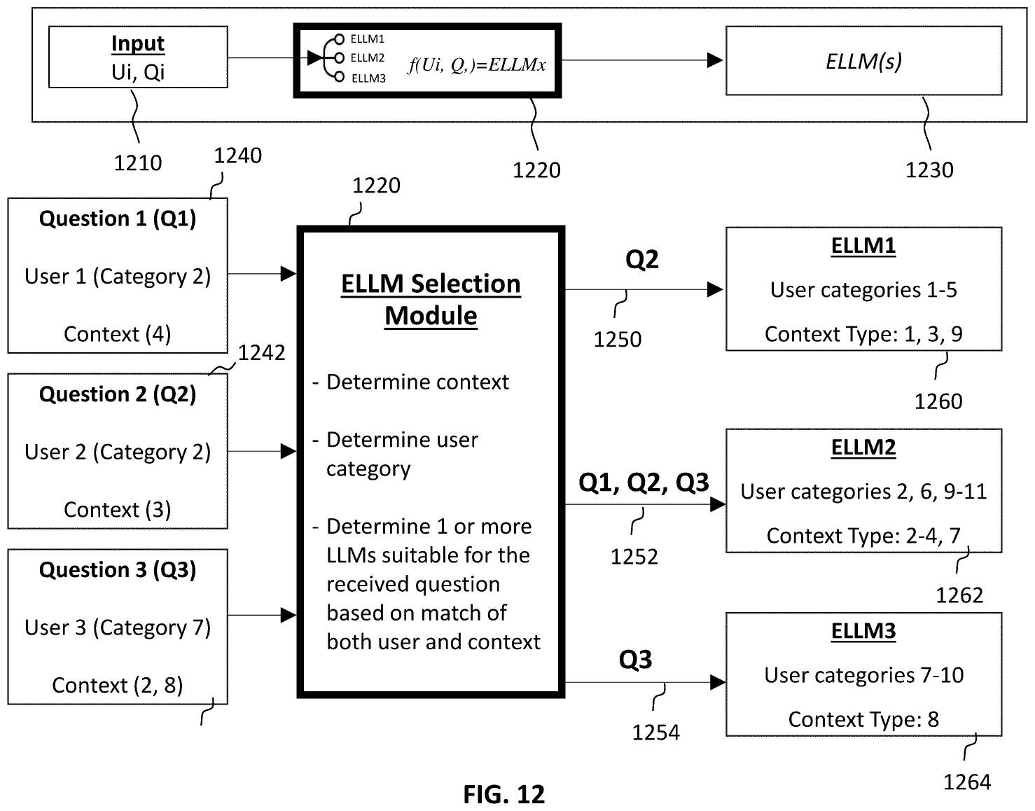

At block 930, also depicted at block 1020 of FIG. 10, the control circuitry 428 and/or 420 may narrow the number of ELLMs from k ELLMs to n ELLMs, where k is a larger number than n. Some embodiments of narrowing from k ELLMs to n ELLMs are described further in the description related to FIGS. 12-16 and 20A-C.

In some embodiments, one or more factors may be analyzed in the narrowing process. One such factor used may be the content and context of the question received at block 910. In some embodiment, an enterprise may have k number of ELLMs, each ELLM relating to a specific function of the enterprise or a specific department, such as engineering, human resources etc. If results from analyzing the content and context of the question at blocks 910-920 indicate that the question related to finance, then control circuitry 428 and/or 420 may. narrow the k number of ELLMs to only those ELLM that relate to finance. Since context and content of the question received may apply to more than one topic and as such to more than on ELLM, any ELLMs that is available for use and connected to the topic, either the entire question or a portion of the question, may be included in a set of the narrowed n ELLMS.

In yet another embodiment, even within a department of an enterprise or within an ELLM that has been trained with data relating to a specific function, there may be nested or further specific ELLMs that relate to different subtopics or categories within the larger category of the ELLM. For example, an ELLM may be broadly trained with engineering data (i.e., larger category) and further nested or subtopics of ELLMs, such as mechanical engineering, electrical engineering, computer science, may exist within the broader engineering ELLM. In another example, an ELLM may be broadly trained with HR data and sub-categories of resume's, background checks, compensation, HR policies, promotions, employee reviews, benefits, which may be topics under the broader HR umbrella, may each have a specific ELLM under the broader HR ELLM. In such embodiments, the process of narrowing from k number of ELLMs to n number of ELLMs may include not including those specific ELLMs that do not relate to the content and context of the question received.

Continuing with the above example, in some embodiments, if the content and context of the question received relates to HR policies, then the control circuitry 428 and/or 420 may only include the ELLM that relates to HR policies in the narrowed set of n ELLMs. In another embodiment, the control circuitry 428 and/or 420 may select a set of nested ELLM that relate to HR policies as well as the broader ELLM that relates to HR in the narrowed set of n ELLMs. The system may also exclude other ELLMs that are nested underneath the broader HR ELLM but do not relate to HR polices, such as compensation or employee reviews, from the narrowed set of n ELLMs.

In some embodiments, another factor analyzed to narrow k number of ELLMs to n number of ELLMs may include the identity of the user from whom the question is received. In an enterprise setting, the user may be a CEO, VP, manager of a specific department, an associate, a new hire, a consultant that has been hired for a short duration to work on a specific project, or another category of employee. Since the level of access to confidential and proprietary enterprise data may vary from user to user, the control circuitry 428 and/or 420 may determine the identity of the user, their authorized level of access to confidential and proprietary enterprise data and include only those ELLMs to which the user is allowed access. For example, an associate may be authorized to access lower level confidential and proprietary enterprise data, a contractor may not be authorized to access any confidential and proprietary enterprise data, and a CEO may have the highest level of authorization to access any and all confidential and proprietary enterprise data. In another example, a manger in an engineering department may be authorized to access all engineering data but not any data from the finance department. Such user identity and their authorization levels may be considered and only those ELLMs that have been trained with data to which the user is allowed access may be retained in the narrow set of n ELLMs.

In some embodiments, both a combination of the content and context of the question and the user identity together may be considered in narrowing from k number of ELLMs to n number of ELLMs. In some embodiments, first the context of the question may be used to narrow from k number of ELLMs to n number of ELLMs and then the remaining ELLMs may be further narrowed based on the user identity. In other embodiments, first the user identity may be used to narrow from k number of ELLMs to n number of ELLMs and then the remaining ELLMs may be further narrowed based on the content and context of the question. In yet another embodiment, some combination of both the content and context of the question and the user identity may be used to narrow from k number of ELLMs to n number of ELLMs. In yet other embodiments, the control circuitry 428 and/or 420 may place certain weights on which factor to consider more in the narrowing process. In some embodiments the control circuitry 428 and/or 420 may place a higher weight on user identity than the content and context of the question and in other embodiments the control circuitry 428 and/or 420 may place equal weight on both user identity and the content and context of the question in the narrowing process. Although user identity has been discussed above in terms of the user's association with a department, type of job role, level of access provided to confidential and proprietary data, the user's contractor or employee status, and various other enterprise related contexts as described herein, the embodiments are not so limited. In other embodiments, user identity may also be used to establish the proficiency or level of understanding of a user. For example, an engineer with 2 years of experience and an engineer who is head of the department or has several years of engineering experience may have different levels of understanding. As such, the systems may also take into consideration the user's identity with respect to level of understanding to select an appropriate LLM or ELLM or further in the process, such as at block 980 of FIG. 9, to blend answers from different ELLMs and/or LLMs that is suitable for the level of understanding of the specific user.

In some embodiments, another factor analyzed to narrow k number of ELLMs to n number of ELLMs or from a k number publicly available LLMs to n number of publicly available LLMs may include cost of processing. In this embodiment, each LLM may have a cost of processing associated with it. The cost may vary from one LLM to another LLM and may be dependent on may factors, such as cost of computing to produce a response or an answer to the question presented in a chat box. For example, relating to public LLMs, a same question presented to ChatGPT™, Bard™, Llama™, Bing chat™, Claude™, and Jasper™, may result in different costs to the user. In this embodiment, the user may provide a upper limit for the cost, or a cost window, or some other cost related criterion. Accordingly, the reduction from k number of ELLMs to n number of ELLMs or from a k number of publicly available LLMs to n number of publicly available LLMs may be based on the user provided cost parameters. In other embodiments, the system may automatically select the least cost alternative and use an LLM that has the least cost associated with providing the answer.

In some embodiments, another factor analyzed to narrow k number of ELLMs to n number of ELLMs or from a k number of publicly available LLMs to n number of publicly available LLMs may include accuracy. In this embodiment, each the user may determine the level of accuracy they desire for a response or an answer to a question they presented in the input area of an LLM chatbot. A user may be willing to live with an average or low level of accuracy for simple questions, such as a middle school math problem or for writing a thank you letter and desire a high level of accuracy for critical problems. For example, if the question posed to the LLM is desiring to seek a solution that would impact a company's sales, a job prospect, debugging of a bug in a critical software, then the user may desire a higher level of accuracy and be willing to pay for the higher level of accuracy. Since accuracy may relate to computing power, e.g., a higher level of accuracy for a complex problem requiring higher usage of computational resources and thereby incurring more costs, the user may reserve seeking a higher level of accuracy for more important and critical tasks. Accordingly, in an example where accuracy parameters are described and the question is presented to LLMs such as ChatGPT™, Bard™, Llama™, Bing chat™, Claude™, and Jasper™, the system may narrow the selection of the LLMs based on the accuracy parameters.

In yet other embodiments, both cost and accuracy collectively may be balanced to narrow k number of ELLMs to n number of ELLMs or from a k number of publicly available LLMs to n number of publicly available LLMs. In this embodiment, the user may define their cost and accuracy parameters and the system may narrow the k number of ELLMs to n number of ELLMs or from a k number of publicly available LLMs to n number of publicly available LLMs based on the provided parameters. In other embodiments, the system may analyze cost Vs accuracy for an ELLM or an LLM to provide a response to a query. The system may automatically determine the content and context of the question and based on the determination generate costs and accuracy parameters. These generated parameters may then be used by the system to narrow the number of ELLMS and/or LLMs. The system may also determine a pattern of use by the user that is seeking a response to the query. Machine learning (ML) engines that execute ML algorithms may be utilized by the system to detect a user behavior pattern with respect to cost and accuracy parameters used by the user previously. The user behavior pattern determined may show that the user selected a first set of cost and accuracy parameters for one type of question and a second set of cost and accuracy parameters for a second type of question. Accordingly, the system may match a new query to the pattern to select from different sets of parameters and then narrow the set of LLMs and/or ELLMs based on the generated parameters. In another embodiment, the system, using data obtained from ML algorithm, may determine a relationship between cost and accuracy parameters, complexity of question, importance of question, and what parameters were previously used based on different levels of complexities and importance of the question. The system may use the determined relationship to generate cost and accuracy parameters to select an LLM for a current posed query.

In some embodiments, the system may analyze a cost and accuracy trade-off. In other words, since higher accuracy may require more computational processing power thereby incurring more costs, the system may determine whether there is a benefit to incur the higher costs based on the type of question asked and the importance of the question. Some examples of the cost, accuracy, and combination used to narrow the number of LLMs (or ELLMs) are depicted in FIGS. 20A-C. In FIG. 20A, LLMs 1-4 may provide a costs basis for answering the same query inputted into the LLM. For example, to provide a response to the same query, LLM2 may have the lowest cost basis of 2.8 while LLM4 may have the highest cost basis of 3.9. The system, or the user, may narrow the number of LLMs (or ELLMs) based on the costs and select, for example, LLM2 since it has the lowest costs. The system, or the user, may also select the two (or other number) lowest LLMs (or ELLMs) based on costs. Similarly, in FIG. 20B, LLM7 may provide the highest accuracy and as such may be selected. In other embodiments, the top two, three, or other number of highest accuracy producing

LLMs may be selected. FIG. 20C depicts selection of an accuracy level based on the importance of the question to the user. A question that is very importance, such as question 2 (Q2) having an importance level 8 associated with it, on a scale of 10, may be suitable for an LLM that provides 93% accuracy. On the other hand, a question of lower importance, such as Q1 may be suitable for an LLM that provides 62% accuracy. Although references to tables and LLMs are made in FIGS. 20A-C, the embodiments include ELLMs and other formats of data, such as in charts, graphs, histograms, and other formats may also be used.

Although costs and accuracy has been discussed in terms of different LLMS and ELLMS, the embodiments are not so limited and also apply to a single LLM or ELLM. For example, a single LLM may provide different levels of accuracy at different costs. In such an embodiment, the user (or system) may specify the costs or accuracy parameters and when the LLM reaches the provided parameters it may stop further processing and provide the best answer that can result based on the cost or accuracy parameters provided.

In addition to ELLMs, the control circuitry 428 and/or 420 may also determine k number of publicly available LLMs and narrow them to n number of LLM. The control circuitry 428 and/or 420 may perform the narrowing process by determining which LLM relates to the content and context of the question received, similar to the process used for the ELLMs.

At block 940, once the k number of ELLMs are narrowed to n number of ELLMs, and the k number of LLMs are narrowed to n number of LLMs, the control circuitry 428 and/or 420, in some embodiments, may determine a sequence of use for the narrowed set of ELLMs and LLMs. In other words, the control circuitry 428 and/or 420 may determine which ELLMs and LLMs, from the set of n ELLMs and LLMs, to use first and then use the results from such ELLMs and LLMs to feed into a second set of ELLMs and LLMs, from the set of n ELLMs and LLMs. Once a sequence is determined, at block 950, the control circuitry 428 and/or 420 4.3 may input or feed the question, or a portion of the question into the ELLMs and LLMs based on the determined sequence to obtain an answer to the question. In some embodiments, the entire sequence of which ELLMs and LLMs to use may be determined at the outset and in other embodiments only a first set of ELLMs and LLMs may be determined and based on the output a second set of ELLMs and LLMs may be determined. The process of obtaining an answer may include the ELLMs that have been trained with data relating to the question to provide an answer.

In other embodiments, the control circuitry 428 and/or 420 may simultaneously feed the question received to a plurality of ELLMs and LLMs, use the results obtained from the ELLMs and LLMs, and refine the results by feeding them into a second set of ELLMs and LLMs to obtain a more refined answer. Some embodiments of the sequence of ELLMs and LLMs that may be used are described further in the description related to FIGS. 10 and 17-18.

The control circuitry 428 and/or 420 may in some embodiment break up the question received into private and public components. For example, a question received may be as follows: “Calculate our internal projections for 3^{rd} quarter revenue and provide the steps used for calculating such revenue.” Such a question may include both private and public components. The component of the question which seeks internal projection will be based on company confidential financial data that is not made public. As such, an ELLM that is internal and private and has been trained on such internal finances may be used to calculate the 3^{rd} quarter revenue. The component of the question which seeks steps used for calculating the revenue may be commonly understood principles in finance that may be obtained from public LLMs. As such, the control circuitry 428 and/or 420 may use the private ELLM for the component of the question that requires internal data and public LLM for commonly understood and publicly available methods for calculating revenue.

The sequence referred to in blocks 940 and 950 may be part of a strategy deployed by the control circuitry 428 and/or 420. Once the sequence has been executed, based on the strategy determined, the control circuitry 428 and/or 420 at block 960 may determine whether the strategy needs to be revised. For example, in one embodiment, an original strategy determined may be to use a first set of ELLMs and/or LLMs, from the narrowed set of n ELLMs and n LLMs, in a particular sequence, or simultaneously, and then use the results from the first set of ELLMs and/or LLMs to feed it into a second set of first set of ELLMs and/or LLMs, from the n ELLMs and n LLMs, to obtain an answer. However, either mid-stream into the sequence, such as after the first set of ELLMs and/or LLMs have been used to obtain and answer, or after the execution of the complete sequence which may be to use the first set of ELLMs and/or LLMs and subsequently the second set of ELLMs and/or LLMs, if at any point a determination is made that the strategy needs a revision, then at block 965, the strategy may be revised and the process may be repeated from block 950.

Strategy revision by the control circuitry 428 and/or 420 may be based on any one or more factors. For example, in some embodiments, if the answer from the first set of ELLMs and/or LLMs is not along a direction that is anticipated, is incorrect, incomplete, or seems inaccurate, then the control circuitry 428 and/or 420 may select a different set of ELLMs and/or LLMs to process the question. In other embodiments, multiple strategies may be deployed simultaneously to obtain different sets of answers from each strategy. Whatever the reasons may be to revise the strategy, when such a determination is made, a new sequence of ELLMs and/or LLMs may be used to obtain an answer.

At block 970, the control circuitry 428 and/or 420 may obtain answers from all the ELLMs and/or LLMs as part of the sequence and strategy deployed in blocks 950-965.

At block 980, the control circuitry 428 and/or 420 may blend the answers obtained at block 970. The blending process, in one embodiment, may include selecting portions of answers from different ELLMs and/or LLMs and combining them such that make logical sense. In a non-limiting example, in one embodiment, a first portion of an answer my relate to finance and a second portion of the answer may relate to sales. In this embodiment, two ELLMs that are used may provide an answer with respect to both the first portion and the second portion. However, the first ELLM, of the two ELLMs used, may be trained with finance data and the second ELLM used may be trained with sales data. Analogues to hiring experts in each field (finance and sales), the control circuitry 428 and/or 420 may retain portion of the answer that relates to finance and obtained from the first ELLM trained with financial data and retain portion of the answer that relates to sales and obtained from the second ELLM trained with sales data. The control circuitry 428 and/or 420 may blend both the portions of the answer retained and present them as one answer. To do so, the control circuitry 428 and/or 420 may modify the first and second portion of the answer such that the blended answer grammatically, coherently, and logically flows together as one answer.

In some embodiments, blending may be performed by concatenating multiple answers and grammatically, coherently, and logically joining them to generate a blended answer. In other embodiments, blending may be performed by using a set of predetermined rules for blending two or more answers together. The rules may be automatically generated by the system or provided by a user of the system. In yet other embodiments, blending may be performed based on linguistic rules to ensure that the blended answer, which is a combination of two or more answers received from different ELLMS or LLMS, are linguistically sound. For example, words from two different answers may be subject of a lexical blend or a portmanteau to generate a blended word. Likewise, sentences may be blended to provide a single sentence that is linguistically sound. In yet other embodiments, blending may be associated with summarizing two or more answers received from different ELLMS or LLMS to generate a single answer.

At block 985, the control circuitry 428 and/or 420 may input the blended answer into an ensemble model, such as the ensemble model 1060 in FIG. 10. In some embodiments, the ensemble model may be a ruled-based model that has its own rules on how to determine the better answer. In other embodiments, the ensemble model may be a neural network-based model that can be used to determine the better answer. In yet another embodiment, the ensemble model may be a transformer-based model. The ensemble model may also be a combination of some of the models. The ensemble model may use as input, K times N number of answers/parameters. These parameters relate are used to predict the next word or phrase in sentence. They are associated with numerical values that define the behavior of the ensemble model and are adjusted during training of the ensemble model to predict the next word with a higher degree of probability. The parameters may be weighted and the weights may be associated with the strength of connections between neurons across different layers in the model. These parameters may include architecture, training data, and model size. The ensemble model may continuously learn from the parameters as they are added and the continuous learning may allow the ensemble model to further refine it ability to make predictions of the next work and accordingly determine a better answer for the question.

At block 990, the control circuitry 428 and/or 420 may obtain a golden answer from the ensemble model and display it to the user from whom the question was received. As used herein, the golden answer may refer to an answer that has been refined one or more times through process 900. An iterative method may be used by the control circuitry 428 and/or 420 to refine the answer obtained from a sequence of ELLMs and/or LLMs. In some embodiments, the ELLMs and/or LLMs may iteratively process the answer through different ELLMs and/or LLMs for a predetermined fixed number of times. In other embodiments the control circuitry may dynamically determine the number of iterations and number of ELLMs and/or LLMs to use to obtain an answer. In yet other embodiments, the control circuitry 428 and/or 420 iteratively process the question using same or other ELLMs and/or LLMs. In yet other embodiment, feedback obtained through the process of using a series of ELLMs and/or LLMs may be used to refine the answer to obtain the optimal or refined golden answer. Although a few variations of sequence of ELLMs and/or LLMs selected to sequentially process the question has been described, including processing the question through a few iterations or based on any feedback learned, the embodiments are not so limited. The control circuitry 428 and/or 420 may select any number of ELLMs and/or LLMs, may select the ELLMs and/or LLMs in any particular order, may repeat or select new ELLMs and/or LLMs as part of a selection strategy, may perform any number of iterations, may reprocess the question through same ELLMs and/or LLMs that have processed the question previously by revising the question and querying the ELLMs and/or LLMs, may dynamically develop a strategy of use of various ELLMs and/or LLMs and/or may determine a formula or pattern in which various ELLMs and/or LLMs may be selected to process the question.

Once the golden answer is determined, the control circuitry 428 and/or 420 may present it on a user interface of the user in a particular format. In some embodiments, the control circuitry 428 and/or 420 may also customize the format of the golden answer and present the answer to the user in the customized format. The control circuitry 428 and/or 420 may access user profile to determine user preferences of obtain user history by executing machine learning (ML) algorithms to determine patterns of answer formats previously preferred by the user and use such data to customize the format of the answer.

FIG. 10 is a block diagram of an example of enterprise and public LLMs and their use to obtain a curated/enhanced answer, in accordance with some embodiments. In some embodiments, process 900 may be applied to the block diagram 1000.

In some embodiments, block 1010 represents a question that may be presented by a user. The question may be a single part question or it may have multiple parts. The question may seek information that is private and confidential to the enterprise, it may be answered by using publicly available data, or it may be a combination of both. It may seek the answer by itself or it may seek both the answer and the steps and reasoning used to obtain the answer. Some examples of questions are depicted in FIGS. 11A and 11B.

In some embodiments, block 1020 represents filtering from k number of ELLMs to n number of ELLMs. The k number of ELLMs, as described earlier in description related to FIGS. 6-8, may be generated by extracting enterprise data, such as at blocks 610, 710, and 810 of FIGS. 6, 7, and 8 respectively. The data extracted may be classified and curated for quality and used to generate and train the k number of ELLMs. Although not shown in FIG. 10, the control circuitry may also a similar filtering process to filer k number of LLMs to n number of LLMs. As described earlier, ELLMs as used herein refer to enterprise LLMs while LLMs, as used herein refer to publicly available, or LLMs available through a subscription or a service that are outside the enterprise setting. Some examples of the filtering process are described in the description related to FIGS. 12-16 and 20A-C below.

In some embodiments, once the ELLMs and LLMs have been filtered to a narrowed set of ELLMs and LLMs, blocks 1030 and 1040 represent selective usage of the narrowed set of ELLMs and LLMs by the control circuitry to obtain an answer to the question from block 1010. The control circuitry 428 and/or 420 may determine a strategy to select certain ELLMs and LLMs and revise the strategy as needed to obtain an answer. Some non-limiting embodiments of ELLMs and LLMs selections used are described in the description related to FIGS. 15-19.

In some embodiments, the control circuitry may obtain answers from each of the ELLMs and LLMs selected as part of the strategy. All the answers obtained may blended at block 1050 using a blending process. The blending process may selectively pick all or portions of answers from each of the ELLMs and LLMs used at blocks 1030 and 1040 to blend an answer that is cohesive, grammatically correct, and logical. The control circuitry 428 and/or 420 may also modify the blended answer to ensure that the answer is cohesive, grammatically correct, and logical.

At block 1060, in some embodiments, the blended answer, may be used as an input into the ensemble model to obtain golden answer. In some embodiments, the control circuitry 428 and/or 420 may reformat the blended answer in the form of a question that is used as an input into the ensemble model.

Also at block 1060, in other embodiments, both the blended answer and the original question from block 1010 may be used as an input into the ensemble model to obtain golden answer. In some embodiments, the blended answer and the original question may be fed into the ensemble model separately to obtain two golden answers to compare and contracts between the two answers obtained. The ensemble model may be a model that may be used to determine a better answer for the question 1010 and the blended answer, which may be reformatted as a question. As described earlier, the ensemble model may be a ruled-based model, a neural network-based model, a transformer-based model, or a combination thereof. The ensemble model may also be a combination of a plurality of selected models. The ensemble model may be used to get a better or a more enhanced and thorough answer to a query.

In some embodiments, a sample or preferred answer may also be inputted into the ensemble model along with the blended answer and the question 1010. The sample answer may be used as training data for the ensemble model to further refine the golden answer.

FIG. 12 is a block diagram of an example of matching an LLM to a question based on the context of the question and the user credentials, in accordance with some embodiments of the disclosure.

In some embodiments, an input into an ELLM selection module 1220 may be a question (Qi) and identity of a user (Ui), as depicted at block 1210. The ELLM selection module 1220 may analyze both the content and context of question Qi and the identity of the user Ui to select one or more ELLMs 1230. The selected ELLMs 1230 may be used for processing the question Qi for determining an answer that may include data to which the User Ui is authorized to receive.

As depicted in FIG. 12, in some embodiments, questions Q1, Q2, and Q3 from users User 1, User 2, and User 3 may be received at blocks 1240, 1242, and 244 respectively. Each user, from the set of Users 1-3, may be associated with a certain category or level of authorized access in the enterprise.

For example, an associate may be authorized to access a certain category of access to confidential and proprietary enterprise data, a contractor may not be authorized to access any category of confidential and proprietary enterprise data, and a CEO may be allowed to access all categories of confidential and proprietary enterprise data. Likewise, employees from one department may not be authorize to access confidential and proprietary enterprise data associated with another department or may be provided limited access. Although such access may be classified in an enterprise based on job title, years of experience, position, rank, etc., for sake of simplification, a category of access is used herein to describe the level of access to confidential and proprietary enterprise data.

In some embodiment, a determination may be made that User 1, who inputted question Q1, is allowed access to enterprise data that falls in Category 2. A determination may also be made that the question inputted by User 1, i.e., Q1, contextually relates to topic 4. As an example, this may be a topic that relates to a function in the enterprise or a department, such as finance or engineering department.

Likewise, a determination may be made that User 2, who inputted question Q2, is allowed access to enterprise data that falls in Category 2. A determination may also be made that the question inputted by User 2, i.e., Q2, contextually relates to topic 3.

Additionally, a determination may be made that User 3, who inputted question Q3, is allowed access to enterprise data that falls in Category 7. A determination may also be made that the question inputted by User 3, i.e., Q3, contextually relates to multiple topics, i.e., topics 2 and 8. Although users may be classified as having access to multiple types of confidential and proprietary enterprise data, including confidential and proprietary enterprise data from different departments based on their authorized access level, and the content and context of the question may relate to more that one category or genre, for sake of explanation and simplification, only certain categories of access and context types are discussed.

In some embodiments, the ELLM selection module 1220 receiving the question from the user may analyze the identity of the user, associate the user with a category of authorized access to confidential and proprietary enterprise data. To do so, the ELLM selection module 1220 may access various enterprise databases, applications, local and cloud storage devices and applications, and any other library in which enterprise data is stored and to which the ELLM selection module 1220 is authorized to access. For example, the ELLM selection module 1220 may access Salesforce's desk.com™ application, Oracle's NetSuite™ application, databases relating to marketing, engineering, facilities, management, or finance departments, data from documents, logs, policies, employee profiles, employee job titles and roles, employee performance reviews, conference call recordings, etc. The ELLM selection module 1220 may, based on the accessed databases, applications, local and cloud storage devices and applications, and any other enterprise data, may determine which category of access is authorized for the user.

In some embodiments, the ELLM selection module 1220 may analyze the content and context of the question received (as described earlier at block 920 of FIG. 9). The ELLM selection module 1220 may use the results of the analysis to classify and categorize the question. For example, analyzing the content and context of the question Q1, the ELLM selection module 1220 may place Q1 in category 4. In other embodiments, the content and context of the question Q1 may have been analyzed prior to the submission of the question to the ELLM selection module, such as by process of FIG. 9.

Based on the identity of the user, the user's authorized access to enterprise data, and the content and context of the question, the ELLM selection module 1220 may select 1 or more LLMs for processing the question. In other words, the ELLM selection module 1220 may determine a match between the input (identity of user and content/context of question) and an ELLM. The ELLM that may be selected as a match by the ELLM selection module 1220 may be an ELLM that has been trained with confidential and proprietary enterprise data to which the user is authorized to access and the training data used to train the selected ELLM may be relevant to the content and context of the question.

In some embodiments, ELLM1 1260 may have been trained with confidential and proprietary enterprise data that may be associated with categories 1-5. The data used to train ELLM1 may contextually relate to context types 1, 3, and 9. Likewise, ELLM2 1262 may have been trained with confidential and proprietary enterprise data that may be associated with categories 2, 6, 9-11. The data used to train ELLM2 may contextually relate to context types 2-4 and 7. Additionally, ELLM3 1264 may have been trained with confidential and proprietary enterprise data that may be associated with categories 7-10. The data used to train ELLM3 may contextually relate to context type 8. Although some categories associated with confidential and proprietary enterprise data and context and content type were described in FIG. 12, the embodiments are not so limited and any ELLM may include one or more categories associated with confidential and proprietary enterprise data and context and content type.

The ELLM selection module 1220 may match both the user access categories and the content/context categories of the question from blocks 1240, 1242, and 1244 with one or more matched ELLMs. As depicted, based on a match, since Q1 is related to context type 4, and User 1 has category 2 level of authorized access to confidential and proprietary enterprise data, the ELLM selection module 1220 may select ELLM2 to process the question from block 1240. This may be because ELLM 2 allows users with category 2 level access to its data and its training data has been classified as associated with context types 2-4, and 7.

Following the same type of analysis, the ELLM selection module 1220 may determine a match between question Q2 at block 1242 and ELLM1 and ELLM 2 and assign the question to be processed by both ELLM1 and ELLM2. The ELLM selection module 1220 may also determine a match between question Q3 at block 1244 and ELLM3 and assign the question to be processed by ELLM3. As depicted, depending on the question and the identify of the user, the ELLM selection module 1220 may select one or more ELLMs to process the question, such as Q2 being processed by ELLM1 and ELLM2. The process described in FIG. 12 may, in some embodiments, be part of the ELLM selection process described at blocks 950 of FIG. 9 and 1030 of FIG. 10.

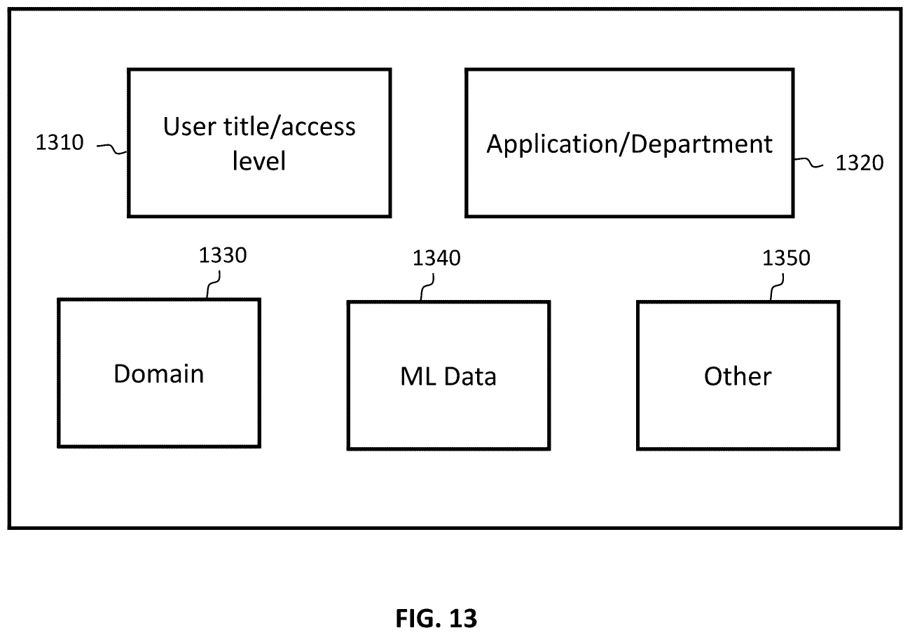

FIG. 13 is a block diagram of an example of selection criteria used for selecting an enterprise LLM, in accordance with some embodiments of the disclosure. The selection criterion used may, in some embodiments, include selection based on user title/access level 1310, application/department 1320, domain 1330, machine learning (ML) data 1340, and other criterion 1350.

In some embodiments, user title/access level may be determined, such as by an ELLM selection module 1220 in FIG. 12. As depicted in FIG. 14, different tiers of access levels may be associated with different tiers of employees based on their job titles. In some embodiments access levels that range from access level 1 (1410), which may be associated with the lowest level of access to confidential and proprietary enterprise data, to access level 5, which may be associated with the highest level of access to confidential and proprietary enterprise data and may be reserved for employees with highest level of clearance to access authorized data, such as the CEO or C-suite employees. Although a few tiers of access levels and associated employees are depicted in FIG. 14, the embodiments are not so limited and other type of tiers and access levels are also contemplated.

As depicted in FIG. 14, access level 1 (1410) may be the lowest access level to confidential and proprietary enterprise data that may be accessed by all employees 1415. Accordingly, if an ELLM has been trained with access level 1 data, such ELLM may be used to process a question from any of the employees 1415 if it includes data that is relevant to the content and context of the question.

Likewise, access level 2 (1420) may be an access level that is higher than the lowest access level 1410 and it may provide access to a higher level of confidential and proprietary enterprise data that may be accessed by managers 1416. Accordingly, if an ELLM has been trained with access level 2 data, such ELLM may be used to process a question from any of the managers 1416 but not all employees 1415. In other words, even if the ELLM that has been trained with access level 2 data may include data that is contextually relevant to a question inputted by an employee 1415, it may not be selected by the control circuitry or the ELLM selection module, since employees 1415 do not have the higher level of authorization required to access data from such an ELLM.

In another embodiment, access level 5 (1450) may be highest access level in the enterprise. In other words, it may be including the most restrictive data that can be accessed only by the employees that have the highest level of authorization. As depicted access level 5 may be restricted to only the CEO, CFO, and COO 1419. Accordingly, if an ELLM has been trained with access level 5 data, such an ELLM may be selected to process questions only if the questions are inputted from CEO, CFO, and COO 1419. Such an ELLM may not be selected by the control circuitry or the ELLM selection module even if it includes data that is contextually relevant to questions inputted from other employees besides the CEO, CFO, and

COO 1419, such as managers 1416, directors 1417, EVPs 1418, since such employees may not be authorized to access data that is categorized as access level 5 data.

FIG. 15 is a block diagram of an example of selecting enterprise LLMs from different departments in a company based on their contextual relationship to the input question, in accordance with some embodiments of the disclosure. In some embodiments, a question 1510 may be received by the ELLM selector 1520. The ELLM selector 1520 may analyze the content and context of the question and determine which department or topic related ELLM is most relevant to answer the question 1510. Since an enterprise may include a plurality of ELLMs, where each ELLM may be associated with a specific department of the enterprise, the ELLM selector may determine based on the question 1510 which department specific ELLM is most relevant to the question and select that ELLM to process the question.

In other embodiments, the ELLM selector may determine based on both the question 1510 and the user asking the question which department specific ELLM is most relevant to the question and select that ELLM to process the question. In some embodiments, if a question relates to HR, however the user asking the question is from the engineering department, the ELLM selector may not use the HR trained ELLM to answer the question. This may be because the user from engineering may not have authorization to access data that has been used to train the HR related ELLM.

In other embodiments, if the question relates to HR and the user asking the question is from the engineering department, the ELLM selector may still select the HR trained ELLM to answer the question, however, it may only use data from the HR ELLM that is allowed to be accessed by employees outside the HR department. As such, even within an ELLM, further distinction may be made through rules configured for the ELLM by the control circuitry, as to which training data may be used based on whether an employee asking the question is authorized to access such data.

In some embodiments, as depicted in FIG. 16, a general ELLM may include further nested ELLM that are more specific within the general topic. For example, a ELLM 1600 for a finance department may be trained with finance data. Within the general finance related ELLM 1600, there may be nested ELLMs such as EMM 1610 for 10 K/SEC filings, ELLM 1620 for forecast, and ELLM 1630 for revenue. If the nested ELLMs 1620 and 1630 are authorized to be used by employees that work in the finance department or only certain employees even within the finance department, such as managers in the finance department, then such nested ELLMs 1620 and 1630 may not be selected to answer questions from other employees outside the finance department.

In some embodiments, the finance ELLM 1600 and its nested ELLM 1610 relating to 10 K/Sec filings (which are public information) may be open to all employees and the nested ELLM 1620 and 1630 may be restricted to employees in the finance department. When a question is asked by a user, the control circuitry or ELLM selector, may determine the identity of the user, whether the user is employed by the finance department, and then determine which nested ELLM to select to answer the question. If all the nested ELLMs 1610-1630 have been trained with data that includes 10 K/SEC filings, and the nested ELLMs 1620 and 1630 includes additional sensitive data related to those filings, even if all three nested ELLMs can answer the question inputted, only ELLM 1610 may be selected if the employee asking is not authorized access to data used for training the other ELLMS 1620 and 1630.

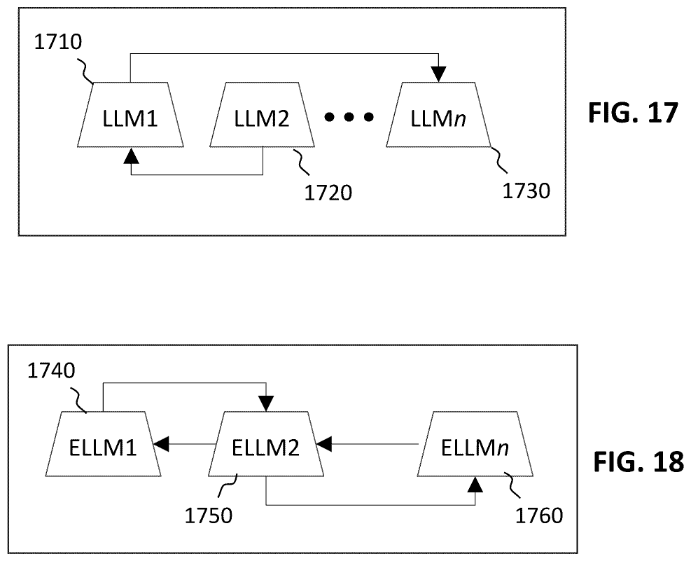

FIG. 17 is a block diagram of an example of using public LLMs to answer a question, in accordance with some embodiments of the disclosure. As described above in blocks 940-965 of FIG. 9 and blocks 1020 and 1040 of FIG. 10, the control circuitry 428 and/or 420 may select a plurality of LMMs to answer the question received. The LLMs selected and the order in which the LLMs are to be used may also be determined by the control circuitry 428 and/or 420. In some embodiments, the order of use may be predetermined and in other embodiments the order of use may be dynamically determined as results are obtained by LLMs that have processed the question. For example, after a first LLM, or a first set of LLMs have processed the question, the results from the processing may be used to determine which LLMs to select to continue processing the question. As depicted, in some embodiments, the control circuitry 428 and/or 420 may select LLM2 1720 to process the question received. Once the question has been processed by LLM2 1720, the control circuitry 428 and/or 420 may select LLM1 1710 to process the results obtained from LLM2. For example, LLM2 may provide an answer which may be used as an input (such as in the form of a question or instructions) LLM1 to obtain a more refined answer. Likewise, results from LLM1 may be used to further process them using LLMn 1730.

FIG. 18 is a block diagram of an example of using enterprise LLMs to answer a question, in accordance with some embodiments of the disclosure. As described above in blocks 940-965 of FIG. 9 and blocks 1020 and 1040 of FIG. 10, the control circuitry 428 and/or 420 may select a plurality of ELMMs to answer the question received. ELLMs are enterprise LLMs that were trained using entries specific data, including confidential and proprietary enterprise data. The ELLMs selected and the order in which the ELLMs are to be used may be determined by the control circuitry 428 and/or 420. In some embodiments, the order of use may be predetermined and in other embodiments the order of use may be dynamically determined as results are obtained by ELLMs that have processed the question. For example, after a first ELLM, or a first set of ELLMs have processed the question, the results from the processing may be used to determine which nest ELLMs or set of ELLMs to select to continue processing the question. As depicted, in some embodiments, the control circuitry 428 and/or 420 may select ELLM2 1750 to process the question received. Once the question has been processed by ELLM2 1750, the control circuitry 428 and/or 420 may select ELLM1 1740 to process the results obtained from LLM2. The control circuitry 428 and/or 420 may select ELLM2 for a second time to process the results obtained from ELLM1 for a more enhanced answer. The control circuitry 428 and/or 420 may then process the enhanced answer received from ELLM 2 and then use ELLMn 1760 to obtain an even more refined answer.

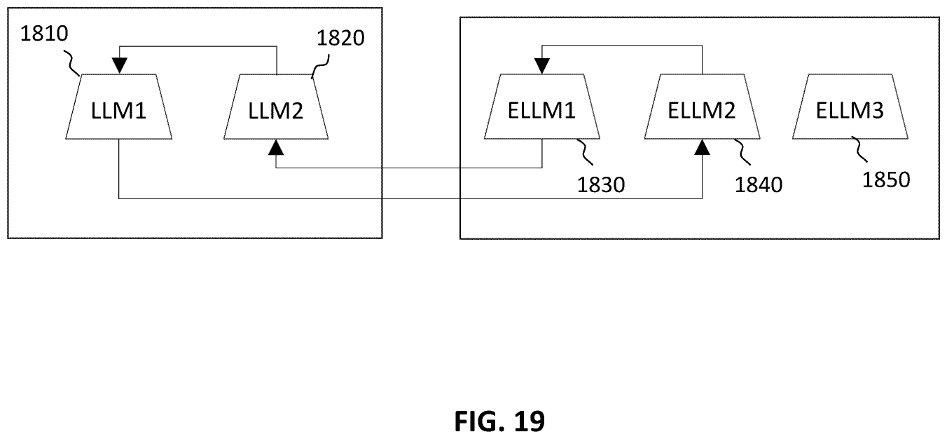

FIG. 19 is a block diagram of an example of using both public and enterprise LLMs to answer a question, in accordance with some embodiments of the disclosure. In addition to only using LLMs or ELLMs, there may be several combinations where both LLMs and ELLMs are used as part of a strategy to answer a question inputted by the user. As depicted, the strategy configured by the control circuitry 428 and/or 420 may be to use the LLMs and ELLMs in the following order: ELLM2 1840→ELLM1 1830 >LLM2 1820→LLM1 1810→ELLM2 1840. Although ELLM3 may have been identified as a potential ELLM for us, the control circuitry 428 and/or 420 may determine not to use it as part of the strategy. The process of using one or more LLMs and ELLMs and using the results from one to process it again using a second LLMs and/or ELLMs or set second set of LLMs and ELLMs may result in the answer continuously getting refined based on additional information gathered along the process and use of different types of training data used in each separate LLMs and ELLMs to answer the question. Such iterative process may be predetermined or may be dynamically determined as results from each LLMs and ELLMs are analyzed. Factors that may be used in determining the next set of LLMs and ELLMs may include, in some embodiments, type of answer obtained, further explanation of concepts presented in the answer, customizing the answer to a specific audience, and clarifying or simplifying the answer obtained from a previous LLMs and/or ELLMs used to process the question. Other factors such as using certain classes of data or quality of data may also be considered in determining which LLMs and/or ELLMs to select. Selectin of LLM, ELLM, or combinations of both LLMs and ELLMs as depicted in FIGS. 17-19 may be based on any of the selection factors described herein, which include based on content and context of question, identify of the user, and cost, accuracy or a combination thereof.

It will be apparent to those of ordinary skill in the art that methods involved in the above-mentioned embodiments may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method comprising:
receiving, from a first user, a question that is to be answered using at least one or more enterprise related large language models (ELLMs);
determining a) an identity of the first user and b) the context of the question received;
selecting the one or more ELLMs based on both the determined identity of the first user and the context of the question for determining an answer to the received question;
receiving at least two answers to the received question, wherein each answer is responsive to the received question and received from a separate ELLM, from the selected one or more ELLMs; and
blending the received at least two answers into a single blended answer.

2. The method of claim 1, further comprising:
using the blended answer as input into an ensemble model; and
executing the ensemble model to generate a final answer.

3. The method of claim 1, further comprising:
generating, at one or more electronic devices, a plurality of ELLMs using enterprise specific data as training data for the ELLMs; and
selecting the one or more ELLMs from the plurality of generated ELLMs.

4. The method of claim 3, wherein selecting the one or more ELLMs from the plurality of generated ELLMs further comprises:
identifying the one or more ELLMs, from the plurality of generated ELLMs, that are trained using a subset of the enterprise specific data that is authorized to be accessible by the first user; and
selecting the identified one or more ELLMs for determining the answer to the received question.

5. The method of claim 3, further comprising:
associating the identity of the first user with a level of access to the enterprise specific data used as training data for the plurality of ELLMs;
determining a level of access associated with the plurality of generated ELLMs;
comparing the level of access associated with the first user with the level of access associated with the plurality of ELLMs; and
selecting the one or more ELLMs, from the plurality of ELLMs, that are associated with a level of access that is same or lower than the level of access associated with the first user.

6. The method of claim 3, further comprising:
associating a plurality of contexts with the plurality of generated ELLMs, wherein the plurality of contexts is determined based on context of the enterprise specific data used as training data for each of the plurality of generated ELLMs;
determining which ELLM, from the plurality of generated ELLMs, is contextually related to the determined context of the question received; and
selecting the one or more ELLMs, from the plurality of generated ELLMs, that is associated with at least one context that is same as the determined context of the question received.

7. The method of claim 1, further comprising:
determining a sequence of ELLMs to use from the selected one or more ELLMs; and
executing the determined sequence to obtain at the least two answers to the question, wherein executing the determined sequence comprises:
selecting a first ELLM, from the selected one or more ELLMs, to obtain a first answer to the received question;
using the obtain first answer as input into a second ELLM, from the selected one or more ELLMs, to obtain a second answer to the received question; and
using the second answer as one of the at the least two answers for blending into the single blended answer.

8. The method of claim 1, further comprising:
selecting one or more LLMs that are trained using publicly available data; and
using a combination of LLMs trained with public data and the ELLMs to receive the at least two answers to the question.

9. The method of claim 1, further comprising:
receiving, from a second user, a second question that is to be answered using the at least one or more ELLMs;
determining that the second user is not authorized to access data that is used to train a first LLM, from the one or more ELLMs; and
in response to determining that the second user is not authorized to access data that is used to train a first LLM, excluding the first ELLM from selection for determining an answer to the second question.

10. The method of claim 1, wherein selecting the one or more ELLMs based on both the determined identity of the first user and the context of the question for determining an answer to the received question further comprises:
iteratively selecting a same of different ELLM, from the one or more ELLMs, to continue processing the received question; and
ending the iterative process after a predetermined number of iterations.

11. The method of claim 1, further comprising, selecting the one or more ELLMs based on cost of processing and accuracy of data provided by each ELLM.

12. A system comprising:
communications circuitry configured to receive, from a first user, a question that is to be answered using at least one or more enterprise related large language models (ELLMs); and
control circuitry communicatively connected to the communications circuitry, wherein the control circuitry is configured to:
determine a) an identity of the first user and b) the context of the question received;
select the one or more ELLMs based on both the determined identity of the first user and the context of the question for determining an answer to the received question;
receive at least two answers to the received question, wherein each answer is responsive to the received question and received from a separate ELLM, from the selected one or more ELLMs; and
blend the received at least two answers into a single blended answer.

13. The system of claim 12, further comprising, the control circuitry configured to:
use the blended answer as input into an ensemble model; and
execute the ensemble model to generate a final answer.

14. The system of claim 12, further comprising, the control circuitry configured to:
generate, at one or more electronic devices, a plurality of ELLMs using enterprise specific data as training data for the ELLMs; and
select the one or more ELLMs from the plurality of generated ELLMs.

15. The system of claim 14, wherein selecting the one or more ELLMs from the plurality of generated ELLMs further comprises, the control circuitry configured to:
identify the one or more ELLMs, from the plurality of generated ELLMs, that are trained using a subset of the enterprise specific data that is authorized to be accessible by the first user; and
select the identified one or more ELLMs for determining the answer to the received question.

16. The system of claim 14, further comprising, the control circuitry configured to:
associate the identity of the first user with a level of access to the enterprise specific data used as training data for the plurality of ELLMs;
determine a level of access associated with the plurality of generated ELLMs;
compare the level of access associated with the first user with the level of access associated with the plurality of ELLMs; and
select the one or more ELLMs, from the plurality of ELLMs, that are associated with a level of access that is same or lower than the level of access associated with the first user.

17. The system of claim 14, further comprising, the control circuitry configured to:
associate a plurality of contexts with the plurality of generated ELLMs, wherein the plurality of contexts is determined based on context of the enterprise specific data used as training data for each of the plurality of generated ELLMs;
determine which ELLM, from the plurality of generated ELLMs, is contextually related to the determined context of the question received; and
select the one or more ELLMs, from the plurality of generated ELLMs, that is associated with at least one context that is same as the determined context of the question received.

18. The system of claim 12, further comprising, the control circuitry configured to:
determine a sequence of ELLMs to use from the selected one or more ELLMs; and
execute the determined sequence to obtain at the least two answers to the question, wherein executing the determined sequence comprises:
selecting a first ELLM, from the selected one or more ELLMs, to obtain a first answer to the received question;
using the obtain first answer as input into a second ELLM, from the selected one or more ELLMs, to obtain a second answer to the received question; and
using the second answer as one of the at the least two answers for blending into the single blended answer.

19. The system of claim 12, further comprising, the control circuitry configured to:
select one or more LLMs that are trained using publicly available data; and
use a combination of LLMs trained with public data and the ELLMs to receive the at least two answers to the question.

20. The system of claim 12, further comprising, the control circuitry configured to select the one or more ELLMs based on cost of processing and accuracy of data provided by each ELLM.
